(19) United States
(12) Patent Application Publication
(10) Pub. No.: US 2025/0144525 A1
(43) Pub. Date: May 8, 2025

(54) SYSTEMS AND METHODS FOR CONNECTED PLAY

(71) Applicant: Q-BA-MAZE Inc., Minneapolis, MN (US)

(72) Inventor: Andrew Comfort, Minneapolis, MN (US)

(73) Assignee: Q-BA-MAZE Inc., Minneapolis, MN (US)

(21) Appl. No.: 18/936,772

(22) Filed: Nov. 4, 2024

Related U.S. Application Data
(60) Provisional application No. 63/595,906, filed on Nov. 3, 2023.

(51) Int. Cl. A63F 13/56; A63F 13/577; A63F 13/67

(52) U.S. Cl. CPC A63F 13/56; A63F 13/577; A63F 13/67

(57) ABSTRACT

The present disclosure, in one embodiment, relates to a computer-based system for virtual navigation that includes a server for managing the virtual navigation of one or more non-player characters, and at least one player console in operable communication with the server over a network. Each of the at least one player console includes a gaming platform for executing a gaming environment, wherein the server generates a virtualized flow of randomly colliding non-player characters, each of which descend through a structure with varying dwell times at one or more chamber nodes and then exits at an end of the dwell time for a given non-player character.

### CROSS REFERENCE TO RELATED APPLICATION

The application claims priority to U.S. Provisional Application No. 63/595,906, filed on Nov. 3, 2023, and titled “Systems and Methods for Connected Play” which is hereby incorporated herein in its entirety.

### FIELD OF THE INVENTION

The present disclosure relates to systems and methods for single or multiplayer virtual game play. More particularly, the present disclosure relates to systems and methods for single or multiplayer virtual game play including creating virtual pathways through built virtual and/or real-world modular member constructions. Even more particularly, systems and methods if the present disclosure relate to one or more computer-based applications that permit saved and shared constructions with a variety of user-friendly and interactive modes.

### BACKGROUND OF THE INVENTION

The present disclosure relates to innovative mixed digital and physical play, also called connected play. Many types of video games are known, as are games for mobile handheld devices like phones and tablet computers. Stacking and interlocking blocks, tubes and bricks are known physical building toys. Less common is the combination of video games and mobile games together with physical building toys.

Marble run toys are a subset of physical building toys which may provide one or more pathways for rolling marbles typically assisted by the force of gravity down a sloped or stepped pathway. There are stacking tube marble runs comprising modular stacking tubes through which marbles fall, entering at the top and exiting out the bottom. Various rails and other stunt pieces provide gentler slopes and extend between tubes in such marble runs. There are also stacking block marble runs often made of wood, typically with straight or curved grooves in the top of the blocks forming the marble pathways.

The interlocking modular marble run of (U.S. Pat. No. 8,475,226 B2, which is hereby incorporated herein by reference in its entirety) introduced a new type of sculptural marble run with modular members allowing interlocking members to form simple marble configurations, such as cascades; or to form complex configurations of twisting turning converging and diverging pathway networks; or to form some degree of complexity between these two.

Digital games or video games come in a wide variety of genres and sub-genres, including: strategy games, action games, sports games, adventure games, puzzle games, casino games, educational games, and (3D) sandbox games. Action games include the sub-genres of platformer games and shooter games—both first person shooter games and third person shooter games. Sports games include racing games, such as car racing games and simulators.

Video games may include player characters controlled by a human player of the game as well as non-player characters (NPCs) controlled by the rules of the game. These characters may move through digital environments such as open or natural landscapes or through and among built objects, buildings and urban environments. In the programming of the game, the movement through these environments may also be simplified or controlled by the use of pathway indicators.

Role playing games and 3D sandbox games in which one or more players may make an environment in which others may later play a video game are known and provide fun and novelty for the participants.

The development of spatial reasoning skill may be an explicit or implicit result of play with either physical building toys or with video and mobile games. The physical manipulation of building toy members with the hands is a known method of developing spatial reasoning. This use of the hands goes beyond the visual and cognitive understanding of the spatial relationship of the building toy members and is known as embodied cognition. A marble run takes the spatial learning a step further than other construction toys by involving not just the construction of an object composed of the stacked or interconnected members, but also the pathway system for marbles to roll through this construction and the effort of the builder in considering the result of member placement on the eventual movement of a marble along the pathway or pathways. Video games may also involve the hands with the operation of a controller or joystick, the spatial reasoning exercise is more visual and cognitive in the video gaming experience compared to hands on placement of physical members.

The toy industry (which produces physical toys) and the video game industry (which makes digital games) largely operate in separate business and product silos, so these two forms of play and these two forms of spatial reasoning development do not come together.

Therefore, there is a need for a connected play system consisting of a modular physical marble run building toy, such as but not limited to that described in U.S. Pat. No. 8,475,226 B2, which may be paired with and/or simulated by one or more mobile apps and/or video games. With such a connected play system, solo and group play may provide many benefits, including but not limited to novel entertainment and spatial reasoning educational experiences for the participants.

### BRIEF SUMMARY OF THE INVENTION

The present disclosure, in one embodiment, relates to a computer-based system for virtual navigation, includes a server for managing the virtual navigation of one or more non-player characters; and at least one player console in operable communication with the server over a network, each of at least one player console comprising a gaming platform for executing a gaming environment, wherein the server generates a virtualized flow of randomly colliding non-player characters, each of which descend through a structure with varying dwell times at one or more chamber nodes and then exits at an end of the dwell time for a given non-player character.

In some embodiments, the one or more chamber nodes include up to five entrances and up to five exits that correspond to up to five entrances and up to five exits on a corresponding number of modular members.

In some embodiments, the system further includes a plurality of the one or more chamber nodes forming a branching pathway for a player and non-player character to move through.

In some embodiments, the system further includes a pathway engine that computes the dwell time for one or more of the non-player characters.

In some cases, the non-player characters are marbles that travel downward along a pathway created by a series of linked pathway modules. In other embodiments, the non-player characters travel upward and downward along the pathway.

In some embodiments of the present disclosure, a computer-based system for connected play includes a server for managing a virtual navigation of one or more non-player characters; and a configuration engine in operable communication with the server over a network, wherein the configuration engine creates a user defined pathway or plurality of pathways for one or more non-player characters to travel through in the virtual navigation.

In some embodiments, the configuration engine further comprises being in operable communication with a virtual world engine.

In some embodiments, the configuration engine further comprises being in operable communication with a rendering engine.

In some embodiments, the configuration engine further comprises being in operable communication with a pathway engine.

In some embodiments, the configuration engine further comprises being in operable communication with a search engine.

In some embodiments, the configuration engine further comprises being in operable communication with a layout engine.

In some embodiments, the configuration engine further comprises being in operable communication with a curation engine.

In some embodiments, the configuration engine further comprises being in operable communication with a configuration test engine.

In some embodiments, the configuration engine further comprises being in operable communication with a spatial reasoning engine.

In some embodiments, the configuration engine further comprises being in operable communication with an artificial intelligence engine.

In some embodiments, the configuration engine further comprises being in operable communication with a virtual world engine, a rendering engine, a pathway engine, a search engine, a layout engine, a curation engine, a configuration test engine, a spatial reasoning engine, and an artificial intelligence engine.

In some embodiments of the present disclosure, a method of connected play for at least one user of a computer-based virtual navigation game includes: opening a digital configuration within an application running the computer-based virtual navigation game; digitally drawing in the application a new configuration of the digital configuration that was opened; saving the new digital configuration in the application; and sharing the new digital configuration in the application.

In some embodiments the new configuration is an iteration of the digital configuration that was opened.

In some embodiments the method further comprises playing the game using the new configuration.

While multiple embodiments are disclosed, still other embodiments of the present disclosure will become apparent to those skilled in the art from the following detailed description, which shows and describes illustrative embodiments of the disclosure. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 illustrates a non-limiting exemplary high level basic server architecture diagram of a network multi-player gaming environment, according to some embodiments of the present disclosure.

FIG. 2 illustrates an example modular configuration control system, according to some embodiments of the present disclosure.

FIG. 3 illustrates an example design/build/game flow diagram, according to some embodiments of the present disclosure.

FIG. 4 illustrates an example configuration iteration flow diagram, according to some embodiments of the present disclosure.

FIG. 5 illustrates an example user experience flow diagram, according to some embodiments of the present disclosure.

FIG. 6 illustrates an example mobile app library overview screen, according to some embodiments of the present disclosure.

FIG. 7 illustrates an example mobile app library filter screen, according to some embodiments of the present disclosure.

FIG. 8 illustrates an example mobile app configuration overview screen, according to some embodiments of the present disclosure.

FIG. 9A illustrates an example mobile app configuration instruction screen, according to some embodiments of the present disclosure.

FIG. 9B illustrates an example mobile app configuration instruction screen, according to some embodiments of the present disclosure.

FIG. 10—Intentionally Omitted

FIG. 11 illustrates an example mobile app workshop home screen, according to some embodiments of the present disclosure.

FIG. 12 illustrates an example mobile app design overview screen, according to some embodiments of the present disclosure.

FIG. 13 illustrates an example mobile app guided learning home screen, according to some embodiments of the present disclosure.

FIG. 14A illustrates an example mobile app configuration design screen, according to some embodiments of the present disclosure.

FIG. 14B illustrates an example mobile app configuration design screen, according to some embodiments of the present disclosure.

FIG. 14C illustrates an example mobile app configuration design screen, according to some embodiments of the present disclosure.

FIG. 14D illustrates an example mobile app configuration design screen, according to some embodiments of the present disclosure.

FIG. 15—Intentionally Omitted

FIG. 16 illustrates an example mobile app configuration design screen, according to some embodiments of the present disclosure.

FIG. 17A illustrates an example mobile app configuration design screen, according to some embodiments of the present disclosure.

FIG. 17B illustrates an example mobile app configuration design screen, according to some embodiments of the present disclosure.

FIG. 18A illustrates an example virtual pathway module, according to some embodiments of the present disclosure.

FIG. 18B illustrates an example superimposed member, according to some embodiments of the present disclosure.

FIG. 18C illustrates an example primitive bounding a virtual pathway module, according to some embodiments of the present disclosure.

FIG. 18D illustrates an example primitive, according to some embodiments of the present disclosure.

FIG. 18E illustrates an example cascade pattern, according to some embodiments of the present disclosure.

FIG. 18F illustrates an example virtual cascade pathway, according to some embodiments of the present disclosure.

FIG. 18G illustrates an example simplified virtual cascade pathway, according to some embodiments of the present disclosure.

FIG. 18H illustrates an example zigzag pattern, according to some embodiments of the present disclosure.

FIG. 18I—Intentionally Omitted

FIG. 18J illustrates an example virtual zigzag pathway, according to some embodiments of the present disclosure.

FIG. 18K illustrates an example simplified virtual zigzag pathway, according to some embodiments of the present disclosure.

FIG. 19A illustrates both an example single-exit pathway module and an example single-exit virtual pathway module, according to some embodiments of the present disclosure.

FIG. 19B illustrates both an example double-exit pathway module and an example double-exit virtual pathway module, according to some embodiments of the present disclosure.

FIG. 19C illustrates both an example L-exit pathway module and an example L-exit virtual pathway module, according to some embodiments of the present disclosure.

FIG. 19D illustrates both an example tri-exit pathway module and an example tri-exit virtual pathway module, according to some embodiments of the present disclosure.

FIG. 19E illustrates both an example quad-exit pathway module and an example quad-exit virtual pathway module, according to some embodiments of the present disclosure.

FIG. 19F illustrates both an example bottom-exit pathway module and an example bottom-exit virtual pathway module, according to some embodiments of the present disclosure.

FIG. 20A illustrates a 125-cube vertically shifted configuration, according to some embodiments of the present disclosure.

FIG. 20B illustrates a 125-cube aligned configuration, according to some embodiments of the present disclosure.

FIG. 20C illustrates an example of one embodiment of modular members in a shifted vertically shifted configuration.

FIG. 21—Intentionally Omitted

FIG. 22—Intentionally Omitted

FIG. 23—Intentionally Omitted

FIG. 24A illustrates an example 16-cube helix, according to some embodiments of the present disclosure.

FIG. 24B illustrates an example intertwined helix, according to some embodiments of the present disclosure.

FIG. 25A illustrates an example cruciform configuration, according to some embodiments of the present disclosure.

FIG. 25B illustrates an example cruciform virtual pathway graph, according to some embodiments of the present disclosure.

FIG. 26A illustrates an example 10-member configuration with an example nested virtual pathway, according to some embodiments of the present disclosure.

FIG. 26B illustrates an example virtual pathway, according to some embodiments of the present disclosure.

FIG. 26C illustrates an example single-exit virtual pathway module, according to some embodiments of the present disclosure.

FIG. 26D illustrates an example double-exit virtual pathway module, according to some embodiments of the present disclosure.

FIG. 26E illustrates an example plan view of a ten-member configuration, according to some embodiments of the present disclosure.

FIG. 26F illustrates an example section view of a ten-member configuration, according to some embodiments of the present disclosure.

FIG. 27—Intentionally Omitted

FIG. 28—Intentionally Omitted

FIG. 29—Intentionally Omitted

FIG. 30 illustrates an example perspective view of a moose configuration according to some embodiments of the present disclosure.

FIG. 31 illustrates an example elevation view of a fish configuration according to some embodiments of the present disclosure.

FIG. 32—Intentionally Omitted

FIG. 33 illustrates an example interior perspective view of a virtual modular member, according to some embodiments of the present disclosure.

FIG. 34A illustrates an example unfolded virtual modular member, according to some embodiments of the present disclosure.

FIG. 34B illustrates an example unfolded virtual modular member, according to some embodiments of the present disclosure.

FIG. 34C illustrates an example unfolded virtual modular member, according to some embodiments of the present disclosure.

FIG. 34D illustrates an example unfolded virtual modular member, according to some embodiments of the present disclosure.

FIG. 35A illustrates example possible openings of a virtual modular member in a triangular arrangement, according to some embodiments of the present disclosure.

FIG. 35B illustrates example possible openings of a virtual modular member in a triangular arrangement, according to some embodiments of the present disclosure.

FIG. 35C illustrates example possible openings of a virtual modular member in a triangular arrangement, according to some embodiments of the present disclosure.

FIG. 36A illustrates an example 12-member configuration in elevation view, according to some embodiments of the present disclosure.

FIG. 36B illustrates an example 12-member configuration in plan view, according to some embodiments of the present disclosure.

FIG. 36C illustrates an example 12-member configuration in perspective view, according to some embodiments of the present disclosure.

FIG. 36D illustrates an example mobile app, according to some embodiments of the present disclosure.

FIG. 37A illustrates three example plan views by layer, according to some embodiments of the present disclosure.

FIG. 37B illustrates three example perspective views by layer, according to some embodiments of the present disclosure.

FIG. 37C illustrates an example multi-layer configuration, according to some embodiments of the present disclosure.

### DETAILED DESCRIPTION

The present disclosure in some embodiments relates to mixed digital and physical play with modular marble run members as both physical objects arranged by hand and as digital versions of these members for use in video games and mobile handheld device apps.

### Physical Modular Marble Run Member Play.

In some embodiments, the physical marble run members comprise a system of generally cubic members, or cubes, as described, for example, in U.S. Pat. No. 8,475,226 B2. In some embodiments of systems and methods of the present disclosure, the physical game members as described in the following patents and publications may also be used and are hereby incorporated herein by reference in their entirety. U.S. Pat. No. 8,475,226, entitled INTERCONNECTING MODULAR PATHWAY APPARATUS, filed Apr. 18, 2006; U.S. Pat. No. D570,425, entitled INTERCONNECTING BLOCK, filed Jun. 7, 2006; U.S. Pat. No. 9,409,097, entitled ACCESSORIES TO A MODULAR PATHWAY APPARATUS, filed Jul. 11, 2013; U.S. Pat. No. D889,567, entitled TRACK CONFIGURATION, filed Dec. 22, 2016; U.S. Pat. No. 11,117,067, entitled INTERCONNECTING MODULAR PATHWAY APPARATUS, filed Sep. 1, 2017; U.S. application Ser. No. 29/764,096, entitled CONSTRUCTION BASE, filed Dec. 28, 2020; U.S. application Ser. No. 29/764,101, entitled SPIRAL CONSTRUCTION BASE, filed Dec. 28, 2020; U.S. Pat. No. D980,336, entitled HANDLE ARMS FOR GAME, filed Dec. 28, 2020; U.S. application Ser. No. 29/764,112, entitled HANDLE RINGS, filed Dec. 28, 2020; U.S. application Ser. No. 29/764,117, entitled CONSTRUCTION PLATFORM, filed Dec. 28, 2020; U.S. Application No. 63/131,302, entitled START AND END COMPONENTS AND METHODS OF MAKING SAME, filed Dec. 28, 2020; U.S. application Ser. No. 17/388,485, entitled INTERCONNECTING MODULAR PATHWAY APPARATUS, filed Jul. 29, 2021; and U.S. application Ser. No. 17/564,067, entitled START AND END COMPONENTS AND METHODS OF MAKING SAME, filed Dec. 28, 2021 are hereby incorporated herein by reference.

It will be understood that embodiments of the present disclosure also include other physical objects and/or physical games, as will be readily appreciated by a person of skill in the art.

The physical marble run members as disclosed in at least one or more of the above-referenced publications and patents are distinct from the members of other marble runs due to: the vertical offset of neighboring or horizontally adjacent cubes; the side joinery allowing both the passage of marbles and the cantilevering of the member over empty space; the side entrances and exits allowing for intricate branching of pathways which may converge and diverge in multi-member configurations in many millions of possible combinations. In addition to the ability to create a range from simple to complex pathway systems for rolling marbles, the physical marble run members in various colors may be arranged to form recognizable representational sculptures such as these non-limiting examples of a tree, flower, robot, butterfly, or bird. Members may be arranged in groupings such as a cascade, zigzag or helix formation and larger configurations may be composed of multiple such groupings. Whether a configuration is an abstract sculptural form or a representational form, like those mentioned above, the entrances, exits, chambers and sloping pathways of the interconnected members working together, may form a branching pathway network allowing marbles to flow from the top to the bottom of the configuration. Such pathway networks may include both diverging and converging paths. Members with more than one exit in such a configuration introduce the opportunity for marbles flowing down a pathway to diverge as they randomly follow one downward sloping branch or another downward sloping branch of the pathway. Multiple members connected to the entrances of another member converge their pathways into this single member such that marbles may enter this member from multiple directions. A person designing a new configuration, therefore, may consider the variables of color, overall sculptural form and stability, and marble pathway design in terms of the amount and pattern of branching, divergence and convergence of the pathway.

### Virtual Pathway Modules and Chamber Form.

It is the form of the chambers and how entrances and exits into and out of the chamber are arranged that distinguishes each modular member type in the physical version of some embodiments of the present disclosure, such as the single-exit, double-exit or bottom-exit members. This form may be translated to CAD geometry, such as polygon models so that marble flow simulated by a physics engine may emulate marble flow through a configuration of the physical members.

Link and node diagrams may represent the exits and entrances of an individual modular member. The composite pathways through a configuration of multiple modular members may be represented with the link and node diagrams of the multiple modular members. A virtual pathway of one modular member may be as simple as a core node associated with up to five potential entrances and up to five potential exits. The links and nodes of multiple members may be coded to create a data model of the configuration of members simplified without having all of the complexity of the CAD geometry of the member and chamber form.

More than just a diagram of the pathway network of a configuration, in embodiments of the present disclosure, the coded links and nodes may be used in the programming of a mobile app or videogame for the movement of both player characters and non-player characters.

### 2D/3D Design Screen.

Plan, section and elevation drawings are orthogonal views, with view planes that are parallel or at right angles to one another. The cubic nature of the modular members of this construction system (in both digital and physical embodiments) are well suited to being viewed in such orthogonal views—from top, right, left, back, front, bottom and cross-section—because the faces of a cube align with the view planes of the orthogonal views.

Perspectival views differ from orthogonal views by showing multiple faces of an object or configuration at the same time. An advantage of orthogonal views arises from limiting the amount of information provided. For example, in a plan view, the perfect symmetry of a configuration may be immediately apparent, where it may only be suggested but not fully revealed in a perspectival view.

There are advantages in understanding a design or configuration that arise from being able to switch back and forth between the orthogonal views and perspective views. These advantages include assisting a user in understanding an existing design and also assisting a user in adjusting a design or making a wholly new design, as the user shifts back and forth from orthogonal to perspective view

For a printed instruction set it is possible to provide perspective views, but these are difficult to provide in a compact form. Plan views of cubic members presented layer-by-layer offer a means of efficiently presenting the layer-by-layer instruction sets for a configuration on a single printed page or two, according to some embodiments of the present disclosure.

A challenge, however, is that users may not understand how to read construction plans that provide only plan views. Accordingly, in some embodiments of the present disclosure, an app that allows a user to shift between plan views (and the other orthogonal views) and perspective views, provides a tool for the user to receive training and experience in reading plan view drawings. Eventually the user may be able to read the plan-only instruction sets discussed above just through the exposure they receive when using the plan views in conjunction with actual physical members and perspective views. Eventually, the user may be able to shed the other inputs and understand a configuration by plan view alone.

In addition to the efficiency of plan-only instructions sets, a user who learns to understand how the various orthogonal views relate to the perspectival view when using embodiments of the present disclosure is also increasing their spatial reasoning capability by practicing mental rotation of objects in their mind—assisted by use of the app.

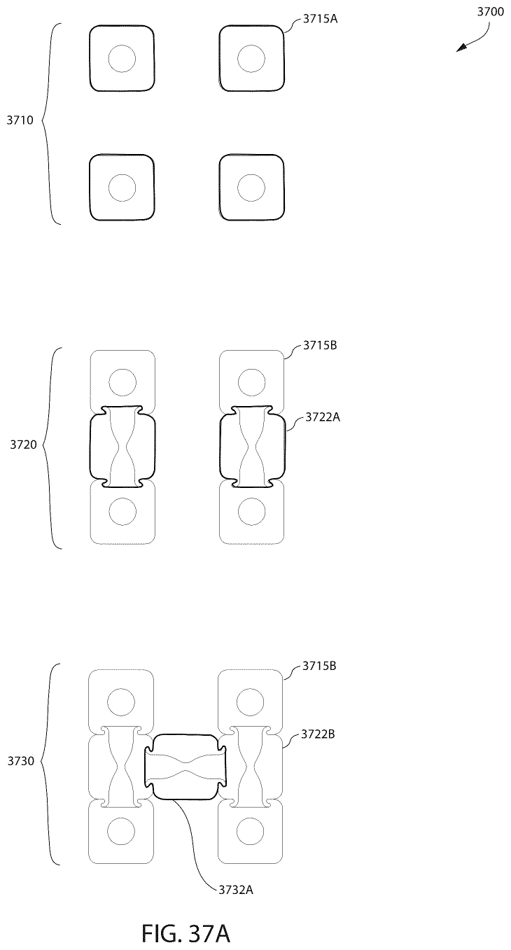

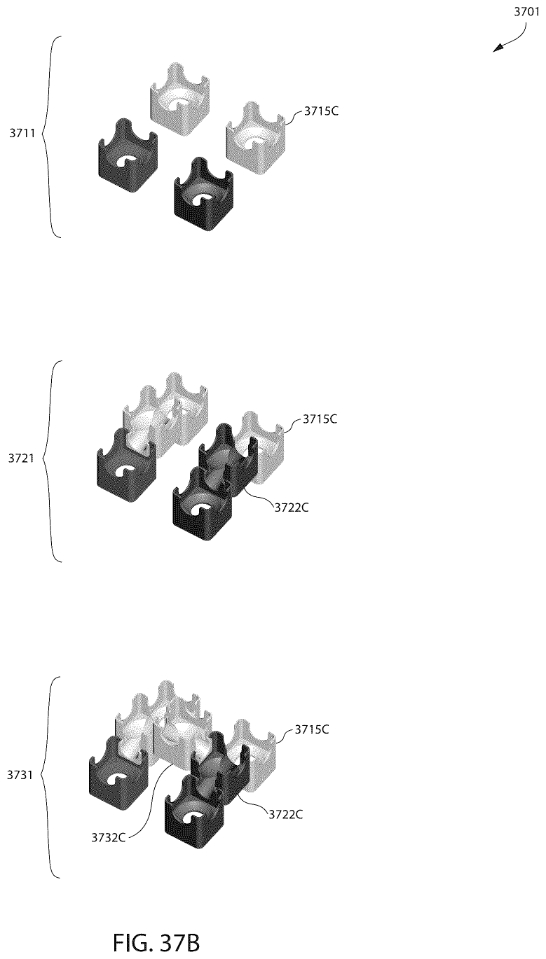

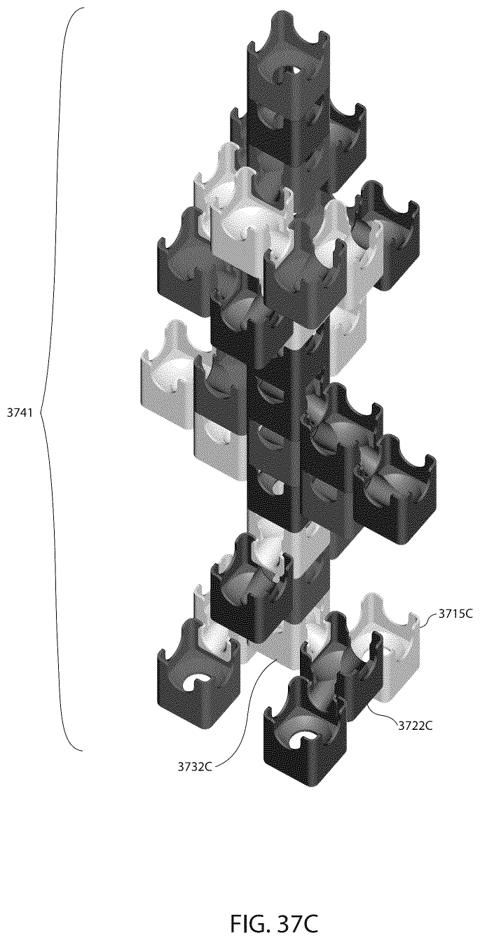

For production of printed plans that may be provided with physical sets of the modular members offered for sale or for printed plans that may be made available in books of instruction sets, there is the problem of how labor intensive it is to draw the instruction plans themselves. An app with a 2D/3D interface and associated menus for selecting members in accordance with embodiments of the present disclosure speeds the ability to draw and save new configuration designs digitally. Once saved, these configuration designs may, with their X, Y and Z positional data regarding the various members in a configuration, be used to automate the layout of instruction sets such as the layer-by-layer plan view instruction sets (see FIG. 37A) and corresponding layer-by-layer perspective views (see FIG. 37B) according to some embodiments of the present disclosure.

### Version Control and Collaboration.

When designing a new configuration of modular members in embodiments of the present disclosure, it can be helpful to make multiple iterations. If designing a configuration meant to look like a fish, for example, it may take multiple iterations before a best configuration is devised which successfully looks like a fish, has structural integrity, has stability, has a good marble pathway network design, and uses the available member colors pleasingly. A user may have a limited number of physical members available. Being able to efficiently and quickly record the iterations with a mobile app according to embodiments of the present disclosure assists in the process of making the new design. It is possible to veer off in a wrong direction while iterating. If iterating with the physical members means needing to disassemble a configuration to make the next iteration, old iterations may be irretrievably lost. By being able to save the iterations digitally with a mobile app according to embodiments of the present disclosure, the iterations are not lost and a user may easily return to a previous idea that was left behind and resume iteration from there as a new starting point.

Digital files of multiple iterations can create a filing and retrieval problem. Without some system, it is hard to keep track of earlier iterations. Accordingly, embodiments of the present disclosure may include design files which may save multiple iterations of a configuration as one design. A preferred iteration of many may be chosen while a plurality of other related iterations may be saved with it. Open a preferred iteration, and the related iterations come with it and may be separately edited. Changing out which of the several iterations is the preferred iteration is just to mark the new favorite iteration as preferred, according to some embodiments of the present disclosure.

When working collaboratively with others, this iteration problem remains or grows larger. The designs with built-in slots for iterations therefore assist with design collaboration as well according to embodiments of the present disclosure.

Design file size may be minimized in embodiments of the present disclosure by saving designs efficiently as CSV or JSON files that store positional data, or X, Y, Z coordinate data, member type data, and other data concerning the members in a configuration, while the memory intensive CAD data need not be stored for every part. The design file just needs to know the member type and the geometry can be called up from a separate data source as needed for rendering the visuals on a screen of an app or other digital tool. This is a compact way to save a configuration without needing to redundantly store CAD geometry for repeated parts.

### Configuration Library.

A library of configurations according to embodiments of the present disclosure can be saved by an individual and a collective library of shared configurations contributed by many users can serve as a source of inspiration and progressively challenging exercises.

The configurations may also be opened in a family of apps and video games in some embodiments of the present disclosure. So the digital experience in some embodiments may be far more than solely an app for drawing, designing, saving and sharing configurations: instead, a plurality of different app and game experiences are possible for use on mobile devices and game consoles in addition to just the design app.

### Mixed Digital and Physical Play and Spatial Reasoning.

Spatial reasoning may be particularly enhanced in embodiments of the present disclosure by being able to explore a configuration of the modular members in multiple ways. In addition to the orthogonal and perspective views discussed above, when playing a video game, a user of embodiments of the present disclosure may take on the perspective of a marble in a first-person view, changing scale and wandering inside a digital depiction of a marble run the user may have built by hand with physical modular members.

The video game in some embodiments need not be constrained to depicting a virtual pathway as though it travels through the physical modular members of the construction toy. The physical environment depicted in some embodiments could be changed, for example, to that of rooms in a stone castle connected by doorway openings. Instead of marbles rolling through, there could be giant boulders and users could band together as teams of yetis blasting the rolling and cascading boulders impeding their path up to the top of the castle.

A user of embodiments of the present disclosure may shift variously from such an imaginative story as this yeti example built up around a pathway, to a more one-to-one depiction of digital modular members representing actual physical members, to looking at the configuration as simple cubic “primitives” in any of the orthogonal or perspective views, to viewing from a bird's eye perspective just the pathway diagram without any geometry denoting the physical nature of the modular members, to setting down any digital device and just manipulating the physical modular members and running actual marbles through a configuration. It is through such a rich flowing experience of embodiments of the present disclosure that spatial reasoning powers may be exercised and enhanced while just having fun at play.

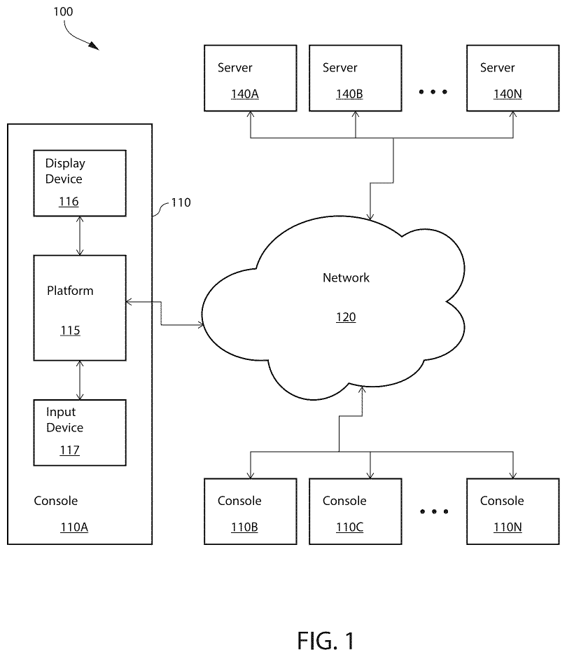

FIG. 1 illustrates a non-limiting exemplary high level basic server architecture diagram showing a communication system in accordance with the non-limiting exemplary embodiments of the present invention. System 100 includes at least one database server 140 coupled with a data network 120 (e.g., local network, the internet, the cloud). A player console 110 can be any system with a processor, memory, capability to connect to the network, and capability of executing gaming software in accordance with the embodiments of the present disclosure. In some embodiments the console 110 may be a handheld mobile device (e.g., iPhone, Samsung Galaxy). Gaming software may include apps available from the Apple App Store or Google Play, or any other apps however obtained. In other embodiments, the console 110 may be any computing device, for example, but not limited to a laptop computer, tablet computer, or desktop computer. In other embodiments the console 110 may be a video game console (e.g., but not limited to Sony PlayStation, Microsoft Xbox, Nintendo Switch). Games or apps may be played solo by one player with one console 110. Games and apps may also be played by multiple players on one or more consoles such as console 110A through console 110N. The input device 117 may be a handheld mobile device screen, keyboard, mouse, touch screen, gamepad, joystick, steering wheel, light gun or other special purpose device for inputting signals. The display device 116 may be for example, a screen, handheld mobile device screen, monitor, projection, headset, goggles, or glasses, or any other display device. In some embodiments, the console 110 may be or may include an augmented reality or virtual reality system which may include a headset, goggles, glasses, or any other existing or after-arising auxiliary device (e.g., HoloLens, Apple Vision Pro, Magic Leap). In some embodiments, the display device 116 and the input device 117 may be the same screen, such as with a handheld mobile device screen.

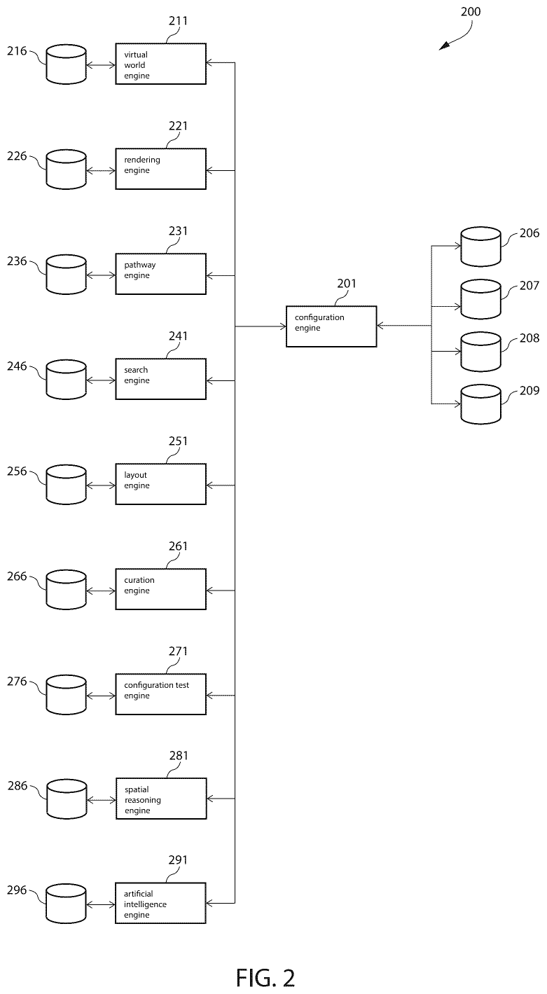

FIG. 2 illustrates a non-limiting exemplary modular configuration control system 200, according to some embodiments. It will be understood that other system configurations, including more or fewer modules, or combination of modules are within the spirit and scope of the present disclosure. System 200 may receive data from one or more player consoles, as in FIG. 1, 110A-110N. Virtual world engine 211 and/or configuration engine 201 may receive and/or determine virtual object data, which may be transmitted to one or more of: virtual world engine 211 and/or associated database 216; rendering engine 221 and/or associated database 226; pathway engine 231 and/or associated database 236; search engine 241 and/or associated database 246; layout engine 251 and/or associated database 256; curation engine 261 and/or associated database 266; configuration test engine 271 and/or associated database 276; spatial reasoning engine 281 and/or associated database 286; or artificial intelligence engine 291 and/or associated database 296. In some embodiments, virtual world engine 211 can be a game engine or a physics engine (e.g., Unity or Unreal), for example. Though it is to be understood that the virtual world engine can be any suitable engine. In some embodiments virtual world engine 211 may receive data from a game engine or physics engine. System 200, virtual world engine 211 and/or configuration engine 201 may receive relative positional information, X, Y, Z coordinate data, object data, color data, object rotation data, object type data, speed data, material composition data, geometry data, pathway data, node data, and/or other data about one or more virtual objects from a player console, a game engine, or a physics engine, for example. In some embodiments, virtual object data can be received from a remote server.

Layout configurations of various types may be saved in one or more databases. In one embodiment configuration engine 201 may save configurations to an individual user configuration database 206, or a collaborative configuration database 207, or a submitted configurations database 208, or an approved configurations database 209, or any combinations thereof.

Databases of configurations may include: a single-user configuration database (in which there is just one designer); a friend group collaborative configuration database (in which more than one user may be the designer); a submitted configurations database (in which the configurations have been submitted by a user for curation and possible inclusion in the app library); a rejected configurations database (for submitted plans that do not pass the process for being included in the app library); curated plans (which have made it through a machine curation process); human curated plans (which have optionally received a further human review); a sandbox database (which include all submitted configurations); a “staff picks” database (which have received a further machine driven approval or optionally some form of further human review). It will be understood that other databases may also be used that may include any subset of configurations that may have been submitted.

In some embodiments, the configuration engine 201 may receive object rotation data that specifies whether an object is rotated north, south, east, west or other compass position. This object rotation data may be recorded in a database and presented to the user such that on a grid of a screen interface, in plan view, the object may be rotated with a chosen face of the object facing to the bottom, the top, the left or the right of the screen, each of these being rotations that are in 90-degree increments, in some embodiments. In other embodiments the rotational position may be in any other degree increment. The north direction may be defined or displayed on a design grid of the user interface, the input device or the output device. Any other data of the configuration engine 201 may also be defined or displayed on the user interface, the input device and/or the output device.

One embodiment may include a virtual world engine 211. Virtual world engine 211 may be a game engine (e.g., but not limited to Unity, Unreal).

One embodiment may include a rendering engine 221. Discussed further below.

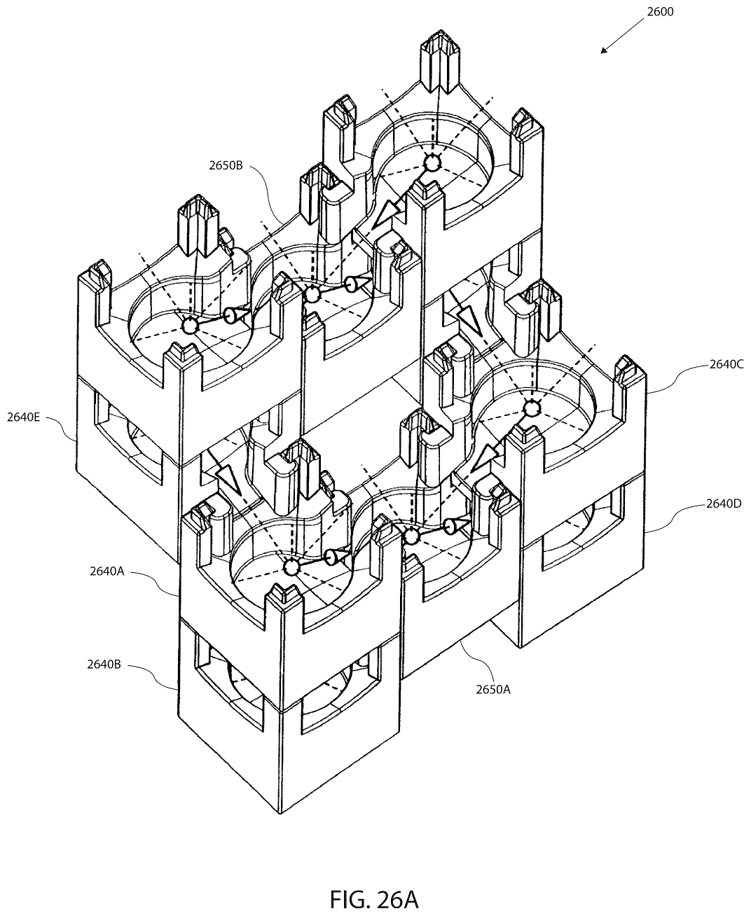

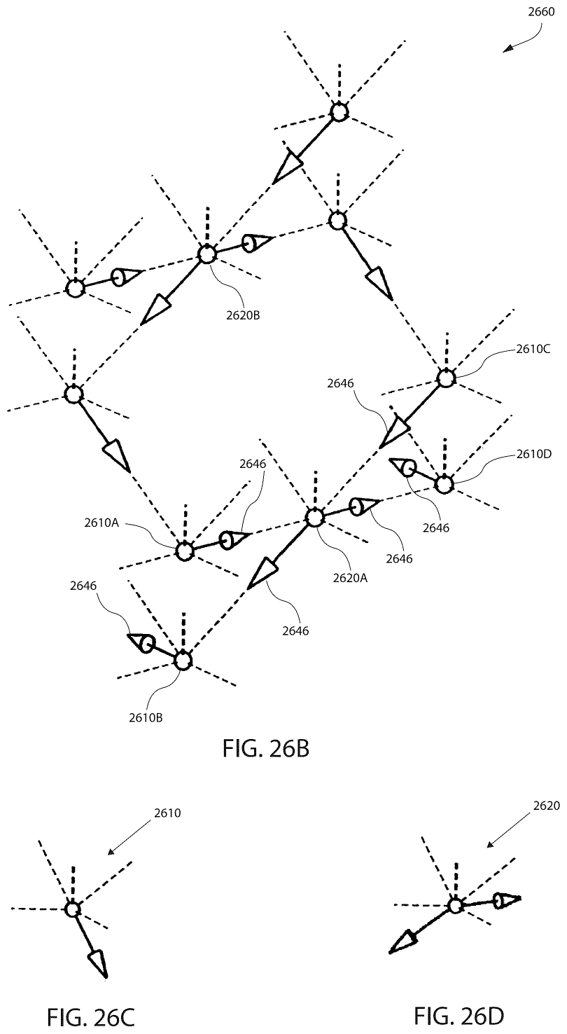

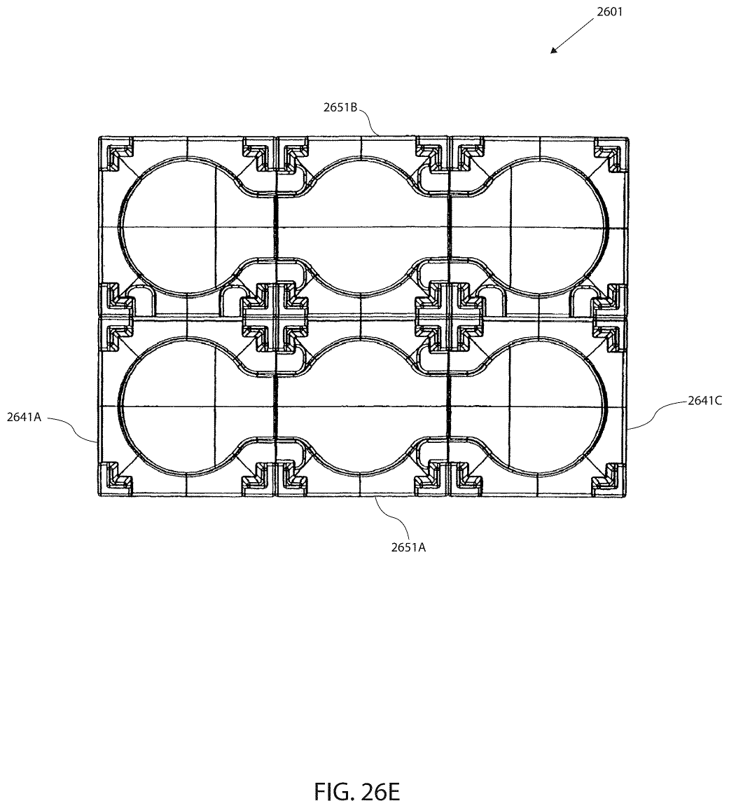

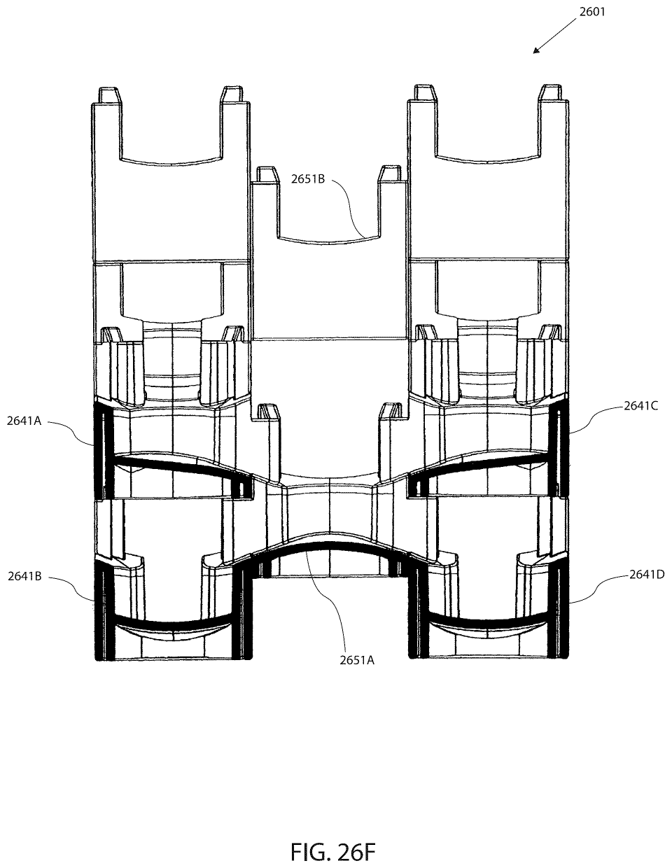

One embodiment may include a pathway engine 231. The pathway engine may compute movement of one or more non-player characters (NPCs) along pathway graphs, such as non-limiting exemplar pathway graph 2610 of FIG. 26B. Flow of marbles or other NPCs down a pathway graph may be simulated by the pathway engine 231. The pathway engine may compute the progress of one or a plurality of marbles or other NPCs down a pathway graph with far less computation than a physics engine calculating collisions between NPCs and NPC collisions with modular members. A physics engine calculates many variables concerning the physical properties and movement of multiple objects which may be calculated locally or on a remote server. The pathway engine may decrease the computational resources needed with various strategies.

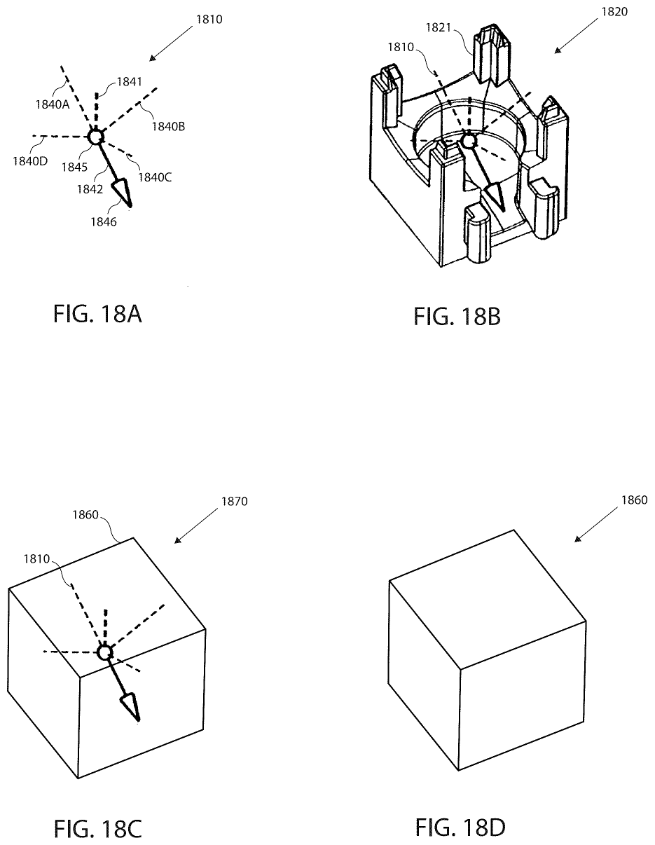

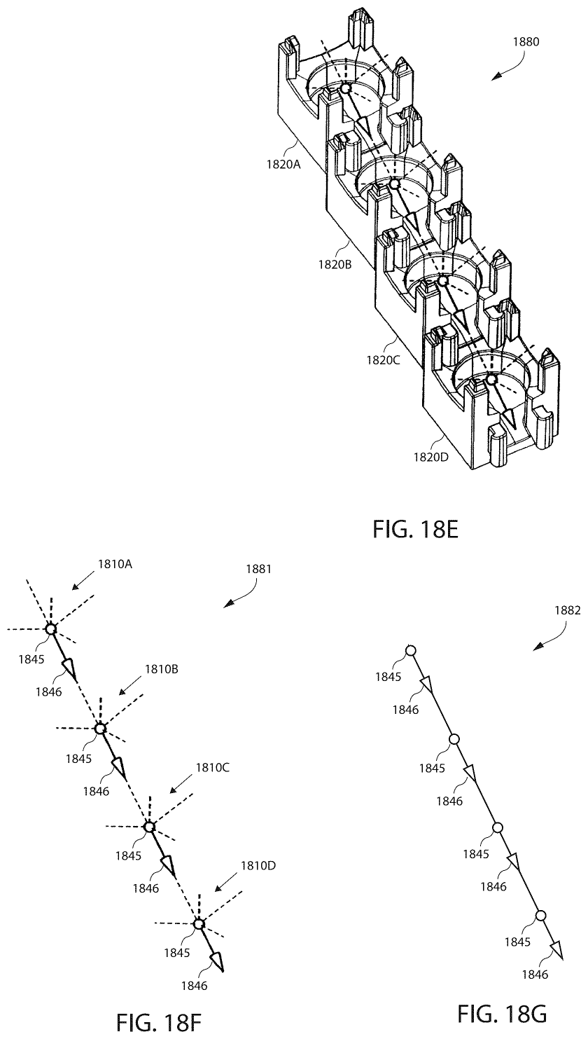

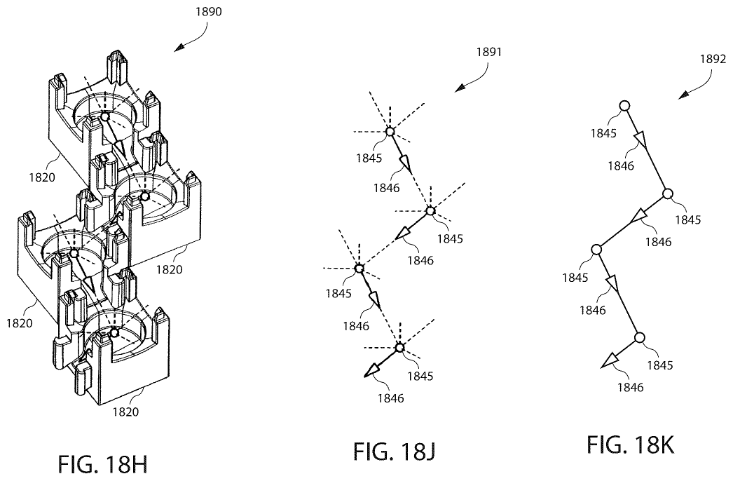

One non-limiting strategy may be to exclude member and NPC geometry and physical characteristics from the calculations and to calculate only the time of entry and exit of NPCs from node to node of a virtual pathway (such as 1891 of FIG. 18J or 2660 of FIG. 26B) which may be composed of a plurality of virtual pathway modules (such as 1910, 1920, 1930, 1940, 1950 and 1960) in various combinations.

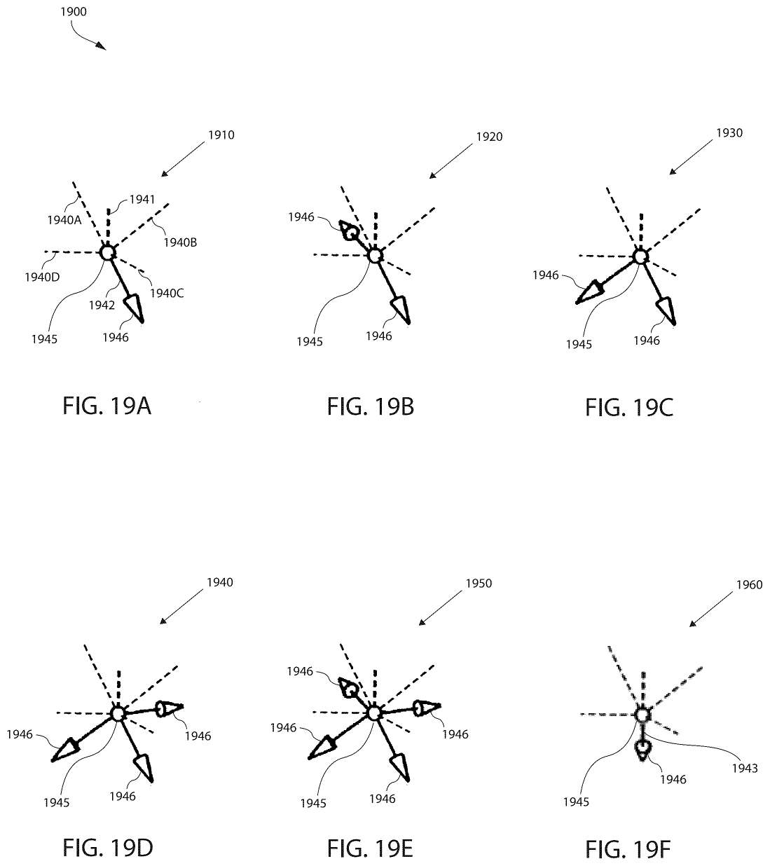

Another non-limiting strategy may be to combine movement of NPCs as calculated efficiently by the pathway engine 231 with the more computationally intensive means of a physics engine or the virtual world engine 211 or the rendering engine 221. For example, when one or more NPCs are descending a virtual pathway and no player character is in a position to see or to interact with such NPC, the movement of the NPC could be calculated efficiently by the pathway engine. But once a player character and NPC are close, such as at the same core node (such as 1945 of FIG. 19A) in a multi-member configuration, then the movement of the NPC could include movement calculated by a physics engine or the virtual world engine 211 or the rendering engine 221.

Another non-limiting strategy may include computations of dwell time as discussed further below.

In one embodiment, pathway engine 231 may compute dwell time for one or more NPCs exiting one pathway module as may be seen in 1810 of FIG. 18A and entering a next pathway module of a series of connected modules as may be seen in 1891 of FIG. 18J. Pathway engine may include arrival time, direction of travel, and/or direction of travel, for example.

In one embodiment, pathway engine 231 may allow movement of player characters of a game in any direction along a pathway graph, such as pathway graph 2610 of FIG. 26B. Player characters may move up, down, or along the graph. When depicted in a 3D space with X, Y and Z dimensions, player characters may increase or decrease their Z position on the graph while they may also move horizontally in the X and Y directions.

In one embodiment, data from the pathway engine 231 may be shared to the virtual world engine 211. Player characters who may be on or near a pathway graph may engage with non-player characters travelling along the pathway graph. NPCs that have been efficiently calculated by the pathway engine may lead to the spawning, release or activation of physics-based versions of the NPCs that are in or are entering a space inhabited by one or more player characters, as discussed in more detail below with reference to FIGS. 18-26.

One embodiment may include a search engine 241. Search engine 241 may provide capability for finding pathways and/or configurations that match or have similarity to different search criteria. Non-limiting examples of such search criteria or parameters may include but not be limited to searching for pathways and/or plans with: cascade patterns with a plurality of nodes or members; helix patterns with a plurality of nodes or members; patterns matching or similar to a sample pathway and/or plans selected or drawn or saved by the user; the simple seven base configuration 3731 of FIG. 37B or other base configurations; including specified finial configurations; a search for the same or a similar number of members or member types (e.g. cubes, rails, trampolines); or the same or a similar number of parts of a certain color; or configurations of a total specified height, width, depth and/or volume; or the same or similar results from any of the tests or results by the configuration test engine 271 or curation engine 261, for example.

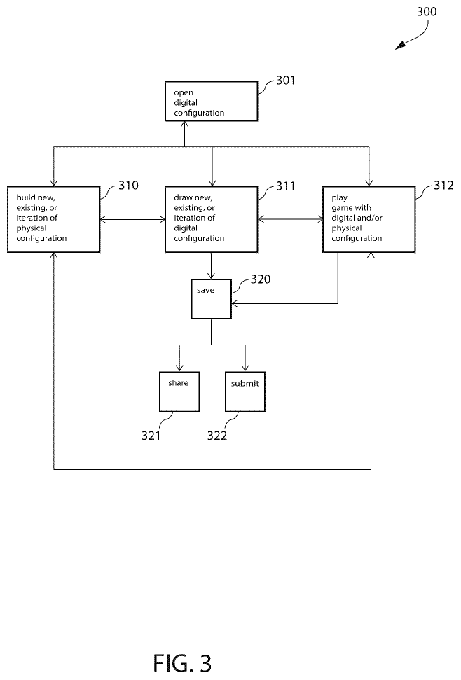

The search engine 241, using search criteria or parameters provided by the user, in one embodiment, may provide a search results list of configurations using data from the configuration engine 201 which may include such criteria or parameters out of the plurality of configurations stored in any of the configuration databases, including, for example 206-209. One or more configurations from this search results list may then be opened and interacted with by the user in at least the ways discussed below with respect to FIGS. 3-5.

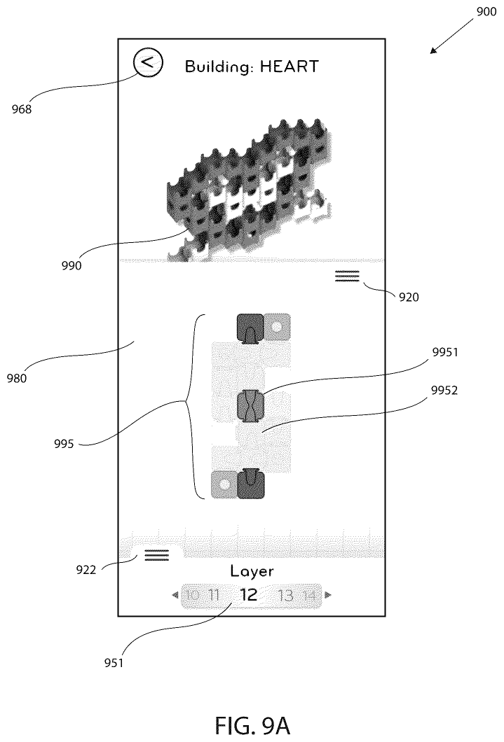

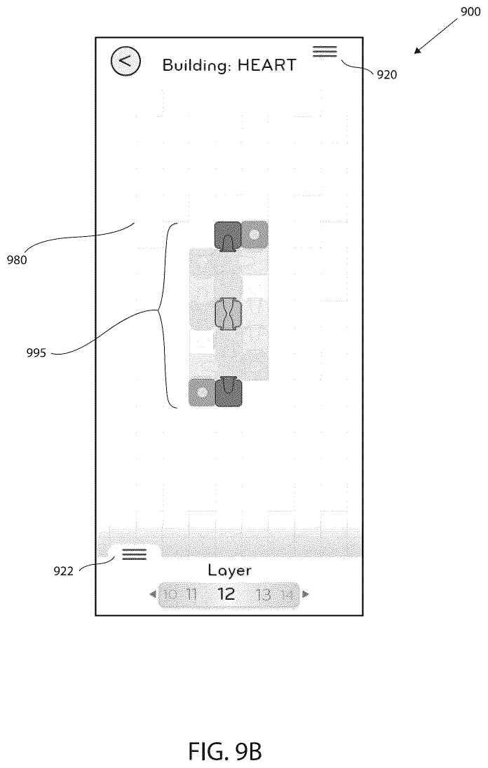

One embodiment of an exemplary system of the present disclosure may include a layout engine 251. Using data from the configuration engine 201, the layout engine may automatically create the layouts seen in the configuration construction screen 900 of FIG. 9, for example.

In one embodiment, together with the rendering engine 221, the layout engine 251 may provide assembly animations viewable via the configuration construction screen 900 of FIGS. 9A-9B or other screens of a mobile app, for example. Assembly animations in some embodiments may show a grid of members lined up in one plane or in stacks organized by color and type, and the animation may show the members travelling through space to assemble into a particular configuration. The configuration may be viewed in perspective, plan, section, elevation and/or a combination of these views during the assembly. The animations may be played back slow and at different speeds or levels of slowness or quickness allowing a user to follow along and build step-by-step with the animation.

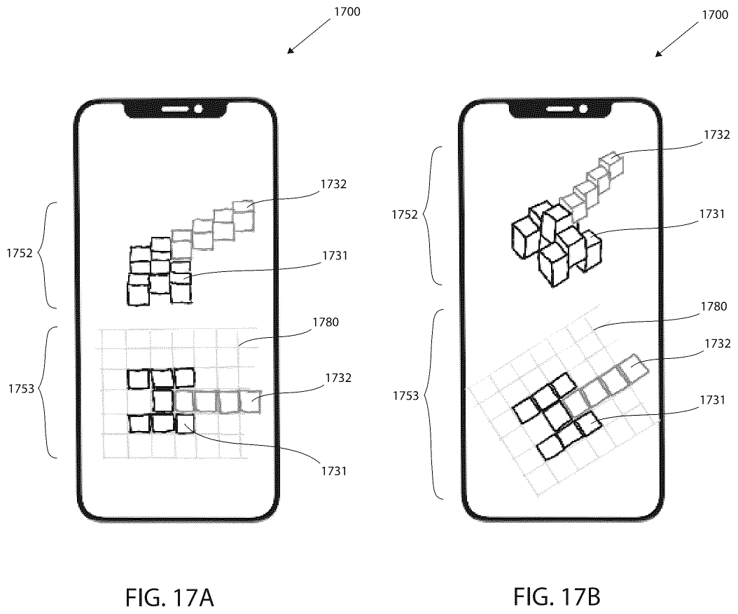

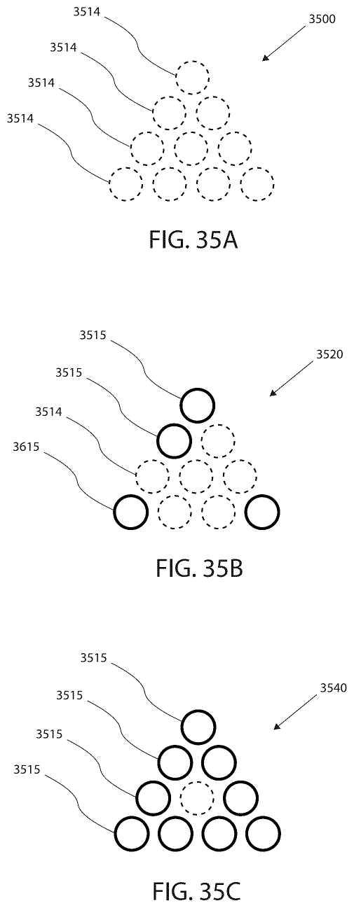

In one embodiment, the layout engine 251 may work together with the configuration engine 201 and the configuration data, for the export of data into composition software or publishing software (e.g., Adobe Illustrator, for example) for assembling 2D line art graphics to automatically make layout pages that may be used for print publication or published as pdfs. For example, step-by-step and/or layer-by-layer instructions for assembling configurations of physical modular members could be produced in this way. Positional information of the digital pathway modules, such as pathway 2660 of FIG. 26B, including X, Y, Z coordinate data could be used from the 3D space of the digital configuration with the Z coordinate data (the height data) determining the layer of a module and the X and Y coordinate data determining the plan view position of the module within that layer. In this way, the composition software may compose a plan view layout of members, such as plan view 2601 of FIG. 26E. As another example, in some embodiments, cubic primitives arranged in the mobile app as a “simple seven” base such as in perspective view 1752 of FIG. 17B, may provide the positional information, or X, Y, Z coordinate data for automating composition software to lay out the layer one plan view 3510, the layer two plan view 3520, and the layer three plan view 3530 of FIG. 35A. A plurality of other configurations may similarly be translated from a digital configuration in the app to a layer-by-layer layout generated with composition software (such as Adobe Illustrator). Of course, other views may also be generated.

One embodiment may include a curation engine 261. Various criteria may be used to evaluate a configuration and provide it a test score that marks a configuration that has been submitted for review as a configuration that has passed this review and may be included in the database of approved configurations 209. Approved configurations may be saved in a separate data base 209 associated with the configuration engine 201. Configurations that have been submitted for review may be saved in a separate database 208 associated with the configuration engine 201. There may also, optionally, be a further step of human review for configurations to be made available to the public through the configuration library. The curation engine may work together with the configuration test engine 271 in determining one or more scores across a range of attributes that may be used for the curation process and determining which submitted configurations are designated as approved configurations that may be added to the approved configurations database 209.

One embodiment may allow evaluation of dwell time of a configuration. A user may be interested in designing a shorter or longer amount of time during which marbles or NPCs may remain in a configuration. This may be calculated by the pathway engine 231 together with the configuration engine 201 and associated data. In some embodiments, there may be a button on or in a pop-up menu, or any other suitable method on a design configuration screen that allows a user to run a dwell time test. Such a test may initiate the launch of one or a plurality of marbles or NPCs along a virtual pathway graph. In an iterative process, a user may save a configuration, run a dwell time test, and then adjust the configuration design in an attempt to make the dwell time longer or shorter if desired. Another dwell time test can be run. This cycle may repeat any number of times until user is satisfied with the result. User may also run actual physical tests of a real world build to see if the computed dwell time test corresponds well with actual experimental real-world data. Configurations such as those in FIGS. 21, 26, 30 and 31 are all examples of configurations for which a dwell time test could be conducted with either digital or physical manifestations of these configurations.

The dwell time of a marble travelling through a physical double-exit member varies. In plan view, if the direction of the exit pathways is north-south, then there are four side entrances, one each from the north, south, east and west. Dwell time is longer for a marble entering from the east or west, for a marble entering perpendicular to the direction of the exit pathway (in plan view). This may be due to changing direction by 90 degrees. This may also be due to the form of the floor of the member. In some embodiments, the physical members have a curved floor and marbles entering perpendicular to the direction of exit may spend more time, rocking on this curved floor compared to marbles entering parallel to the direction of exit from the member. These variations of time spent in the member prior to exit are variations in dwell time, in the amount of time spent in the member between entering and exiting the member.

In one embodiment, this dwell time in a digital version of a member may be simulated with a physics engine which may calculate the interaction of the NPC marble with the curved floor of the member. As discussed above, this may be computationally expensive.

In another embodiment, dwell time may be calculated with respect to time and direction of arrival of one or more NPCs to a virtual pathway module, excluding the geometry of the NPC and the member. In the case of a double-exit member, multipliers may be used that increase dwell time for an NPC entering the member perpendicular to the direction of the exit pathway (in plan view). Multipliers may be used that increase or decrease dwell time depending on whether one or a plurality of NPCs is dwelling at a single virtual pathway module at the same time. Time of arrival or order of arrival of NPCs at a virtual pathway module may be included in the calculation of dwell time for any individual NPC. For example, in the case of a first NPC arrived at a virtual pathway module but not yet exited, in other words, for a first NPC currently dwelling at a virtual pathway module, the arrival of a second NPC may impact the calculation so as to shorten (or lengthen) its remaining dwell time.

Experimentally, with the physical members, it has been noticed that marbles tend to have shorter dwell times when descending a configuration in groups than when descending solo. In another embodiment, an app could include settings for adjusting dwell time variables used in dwell time calculations. A user could run marbles through an actual structure, then run marbles through a virtual structure using the app (or console), and then adjust the settings to get the times of marbles descending a virtual configuration to more closely resemble the times of marbles descending an actual physical configuration. Variables that may be included or adjusted in such dwell time settings and calculations may include: virtual pathway type (single-exit, double-exit, bottom-exit, L-exit, tri-exit, quad-exit); pathway type of the previous one, two, three or more virtual pathways; direction of entry; direction of entry compared to direction of exit links or pathways; direction of travel of the NPC through the previous one, two, three or more virtual pathways (thus allowing for adjustment of dwell time depending on whether a configuration is a cascade, a zigzag or another configuration); or dwell time in the previous one, two, three or more virtual pathways.

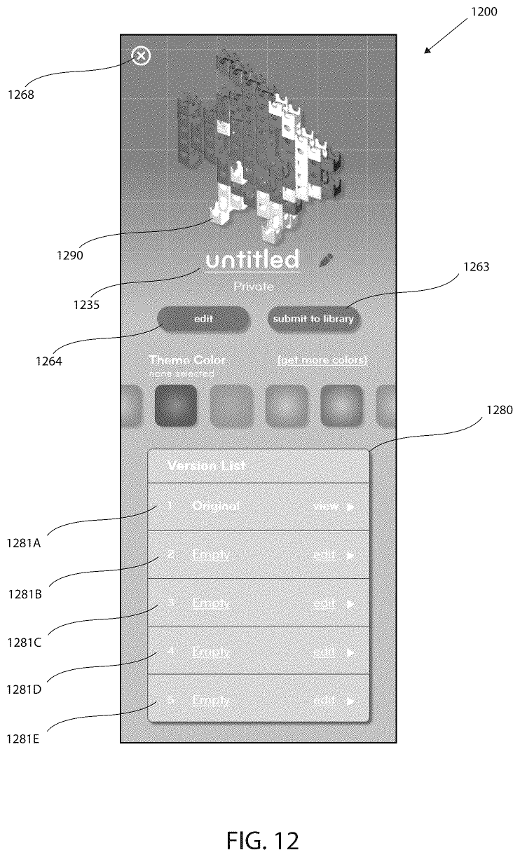

In another embodiment, the curation engine 261 may include data about user interaction or friend group interaction with a configuration. Rules or criteria may be set that would enhance or detract from a curation test score for a configuration. Non-limiting examples of such rules or criteria may include but are not limited to: the number of dwell time tests a configuration receives; or the number of iterations a configuration goes through before it is finally saved, as discussed with respect to FIG. 12; or the number of times a configuration is opened into a configuration instruction screen such as screen 900 of FIG. 9.

One embodiment may include a configuration test engine 271. A configuration test engine 271 may be used by a user to evaluate their single-user configuration design or it may also be used for the curation process and the curation engine 261, for example. It will be understood that it may be used with other processes or engines as well. Criteria for creating a test score or multiple scores across a range of attributes for configurations may include, but not be limited to: good marble flow, such as lack of disconnected pathways; full use of as many members as possible within a single pathway network or pathway graph, such that a high proportion of members are connected to pathway graph via links and nodes; jump evaluation, such as noting what happens with exit pathways above the bottom level that do not connect to another member and thus lead to a jump for a marble or NPC descending down that branch of a pathway, with jumps having appropriately placed catcher members in place, in which the marbles or NPCs may land, and thereby, optionally receiving extra points in the test score; good form, which could be ranked on qualities such as symmetry and balanced asymmetry; good color use, which could be ranked based on pattern; good engineering or stability, which could be scored based upon rules of member placement or could be judged in conjunction with the physics engine that may be a part of the virtual world engine 211.

One embodiment may include a spatial reasoning engine 281. A spatial reasoning engine 281 may include a timer which could track how long a user takes to follow the layers of configuration instructions to build a real-world model. For example, a user looking at a configuration construction screen 900 of FIG. 9A or 9B, may hit a button to start a timer on the screen 900 or elsewhere in the user interface, and begin assembling a real-world configuration with physical modular members. Once the user completes the real-world assembly the user may hit the timer button again to stop it and thus record the assembly time. Alternatively, rather than measuring a race to build a configuration quickly, a timer could be used to measure the length of a play session. Data from the spatial reasoning engine 281 may be used to assist in recommendations of what a user may like to try next, such as some next configuration from the configuration library or some next lesson from guided learning.

One embodiment may include an artificial intelligence engine 291. Scoring of configurations or of users could be accomplished by the artificial intelligence engine 291 trained on data collected by the system 200. In some embodiments, time to complete a construction could be used by the AI for scoring. In another embodiment, data from the user's progress through the guided learning exercises may be used to help serve appropriate next material to the user, such as some next configuration to build or some game to play.

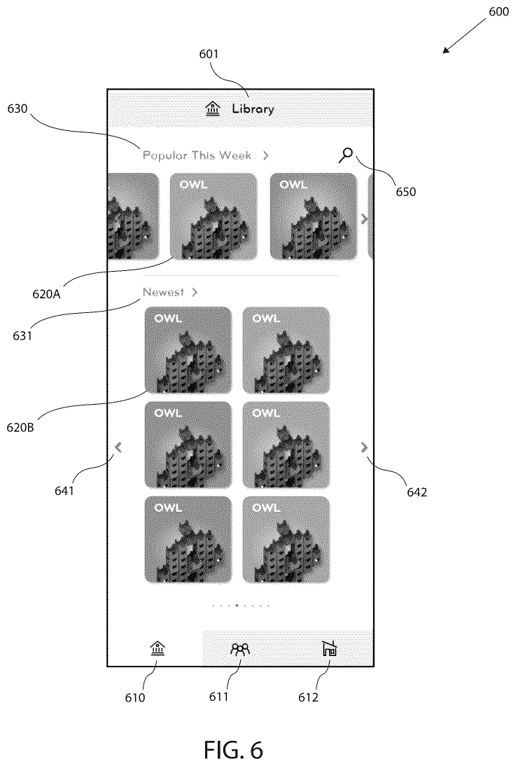

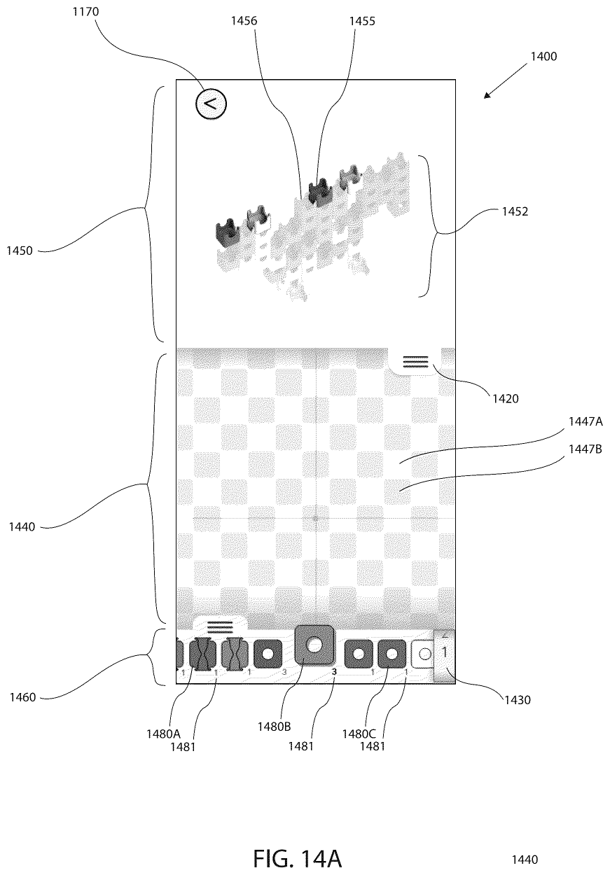

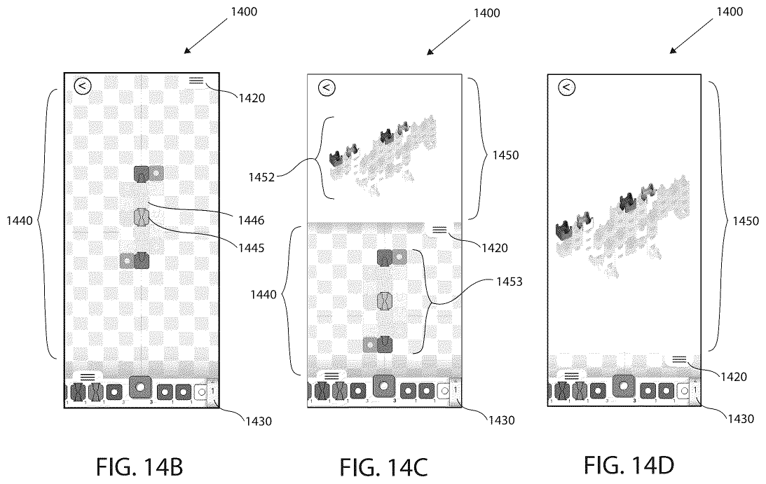

FIG. 3 illustrates a flow diagram showing the steps of a method of how the present invention, in one embodiment, affords a connected play experience. It should be understood that other embodiments may include more, fewer, or different steps. Method 300 includes user actions and digital responses whereby the user may: build physical configurations of physical modular members, at 310 (discussed in more detail below); draw digital configurations which are totally new, which correspond to existing physical configurations, or are iterations of existing digital or physical configurations at 311; save digital configurations for later use, at 320; share digital configurations to another user, at 321; submit digital configurations for review and possible publication, such as to a website or a plan library available through a mobile app, at 322; and use such digital configurations in conjunction with real world physical games or computer games, at 312. Existing configurations, including those saved at 320, may be opened at 301, for use in performing step 310, step 311, and/or step 312. Submitted configurations may be used or stored in the various engines and databases of the system 200 of FIG. 2. The digital portions of this capability are described in more detail through the non-limiting examples of the embodiments of handheld mobile app screens of FIGS. 6-17. In one embodiment, design data may be entered by a user via a mobile app configuration design screen 1400 of FIG. 14. As one example, a user may: draw a new configuration, at 311; use that configuration to play a digital game, at 312; build an iteration of the configuration with physical modular members, at 310; record this iteration by drawing it, at 311; and save this iteration for later use at 320. As an example of sharing configurations: a user may draw a new digital configuration, at 311; save the configuration, at 320; and share the configuration with a friend, at 321; the friend may open the configuration, at 301, and then proceed to do any of building the configuration, at 310, drawing an iteration of the configuration, at 311, and/or playing a game with the configuration, at 312. As another example, the user and the friend (or a plurality of friends) may also proceed through a recursive cycle of iteration, at 311, saving, at 320, sharing, at 321, opening at, 301 and repeating, through multiple cycles during which a configuration may evolve into a preferred variation. Because the arrows in this flow chart point both ways between 301, 310, 311 and 312, there are many possible patterns in which these steps may be sequenced. Any number of different digital games and apps may be devised which employ configurations in their use at 312. Games involving configurations of the physical members may also be devised for play with configurations at 312. And games that combine simultaneous play with digital games and apps and the physical members may be devised for play with configurations at 312.

In some embodiments, data collected in the course of method 300 may be collected in the configuration engine 201 of FIG. 2. This data may include positional data of members, X, Y, Z coordinate data, object data, color data, object rotation data, object type data, speed data, material composition data, geometry data, pathway data, node data, and/or other data about one or more virtual objects, or player characters or non-player characters.

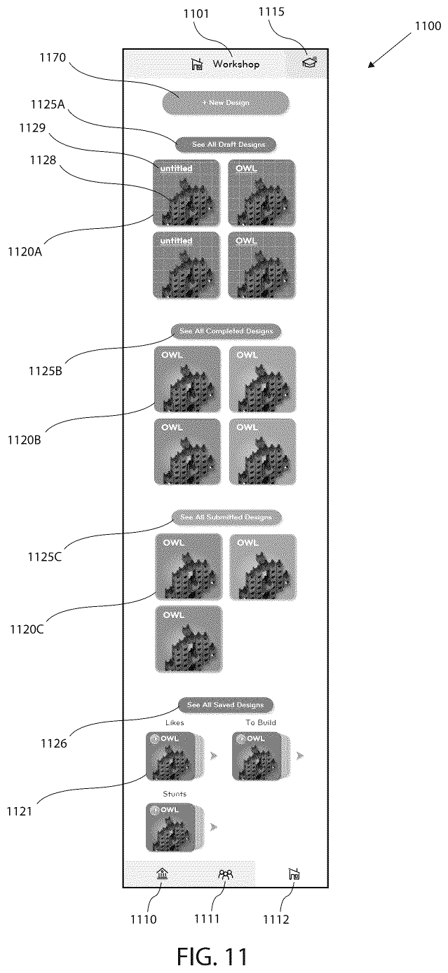

Now referring to FIG. 3: draw new, at 311, corresponds to a user selecting the new design button for example, as shown at 1170 in the workshop 1100 of FIG. 11; draw existing, at 311, corresponds to making a new design based upon some existing model such as a physical configuration, at 310, or some result from a game, at 312; draw iteration, at 311, corresponds to for example, the edit button 1264 as shown in the design overview screen 1200 of FIG. 12.

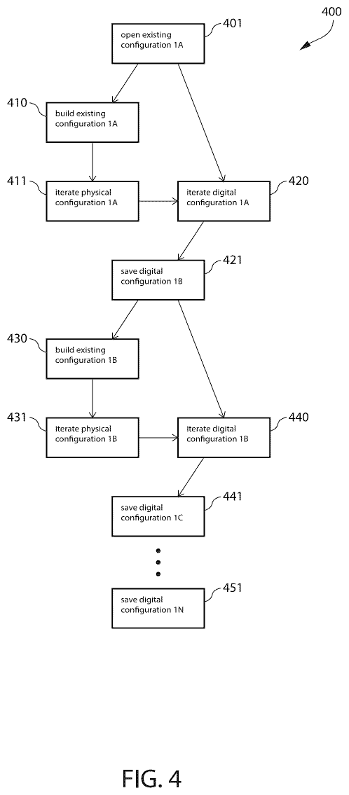

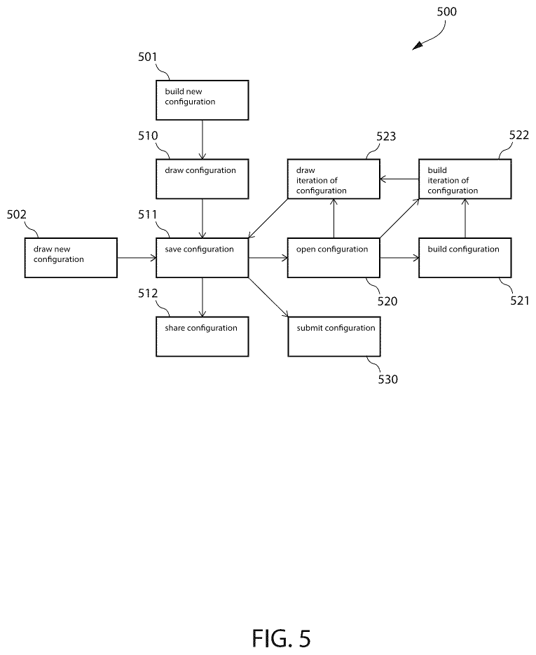

FIG. 4 and FIG. 5 provide a more detailed view of how the iteration process may unfold.

FIG. 4 is a flow diagram illustrating the steps of a non-limiting method of how the present invention, in one embodiment, affords a connected play experience in which one or more users may singly or together iterate (meaning to make new variations of) physical and digital configurations of the members. Method 400 includes user actions and digital responses whereby the user may: open a configuration 1A on a console at 401; build configuration 1A with physical members at 410, while following steps that may be provided by opening the configuration 1A on the console at 401; make a new version, and/or a new iteration of configuration 1A by changing any number of the members of configuration 1A at 411; record this new configuration from 411 in digital form using a console at 420; alternately, after opening configuration 1A at 401, immediately make a digital iteration, and/or version of configuration 1A at 420, bypassing the step of building configuration 1A with physical members at 410; and save the iteration of configuration 1A as a new configuration 1B at 421. Such new configuration 1B may be saved to the configuration control system 200 of FIG. 2.

After saving configuration 1B at 421, a user may proceed through a further iterative cycle by: building iteration 1B with physical members at 430; iterating a new version of configuration 1B at 431; recording configuration 1B at 440; skipping the physical portion of the iteration cycle and proceeding directly to recording a new configuration 1B at 430; and saving the new iteration of configuration 1B as configuration 1C at 441. This iterative cycle may proceed indefinitely to the saving of a configuration 1N at 451.

At any time, any iteration of configuration 1A to configuration 1N which has been saved for later opening may be opened at 401, thus launching a new iterative cycle.

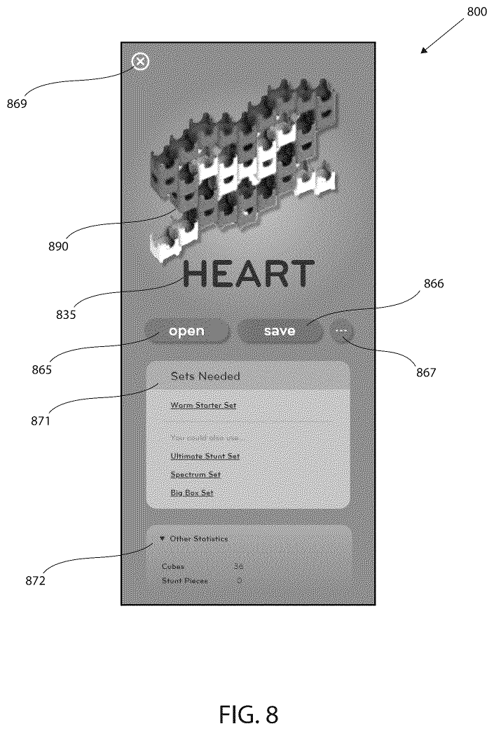

Referring to FIG. 4, an iteration flow chart 400 is provided. This chart shows how a user may iterate configurations (which may also be called pathways in some embodiments depending on intent, e.g., whether the user is thinking more about making pathways for use in digital games, or is thinking particularly about how marbles will flow on pathways versus if the user is thinking more about a model that is being created such as, for example, a model looking like a fish or a butterfly). A user may open an existing configuration 1A at 401. This corresponds to selecting the open button on a configuration overview screen 800 of FIG. 8. It may also correspond to selecting the edit button on a design overview screen 1200 of FIG. 12, as discussed below in more detail.

The user may build a physical real-world version of this configuration 1A at 410. The user may build an iteration, a variant, of this configuration 1A at 411. The user may draw this iteration of configuration 1A digitally using a console at 420. The user may, alternatively, skip the process of building a physical real-world model of the configuration and go straight to making or drawing the digital iteration at 420. The user may then save this iteration which the user may ascribe any name to, but which for the purposes of this flow chart is called configuration 1B at 421. There may be a save button associated with the design screen, for example as may be seen at 1400 of FIG. 14A or the app may have automatic saving, or both. This process may then repeat at 430, 431, 440, 441 and so on. In some embodiments, with a design that has been shared to a friend or a plurality of friends, any of the friends may open and iterate the design or configuration following this general pattern of the iteration flow chart.

FIG. 5 illustrates a flow diagram illustrating the steps of a non-limiting method of how the present invention, in one embodiment, affords a connected play experience in which one or more users may singly or together build, draw, save, share, submit and/or open configurations. Method 500 includes user actions and digital responses whereby the user may: build a new configuration with physical members at 501; draw this configuration in digital form using a console at 510; save this configuration in digital form using a console at 511; share this configuration with one or more other users using a console at 512; and submit this configuration using a console at 530 for possible inclusion in a publicly available library or database of configurations as described below in more detail with respect to FIG. 12. Alternately, the user may: skip the physical building of a new configuration at 501, and immediately draw a new configuration using a console at 502. After which the user may proceed as above with saving the configuration at 511, and sharing the configuration at 512, and/or submitting the configuration at 530.

A user may also open any saved configuration using a console at 520. A user may build the configuration with physical members at 521, by following the information provided about the configuration on a console at 520. Having built the configuration with physical members, the user may make an iteration of this configuration by changing, adding or subtracting any number of members at 522. The user may then draw this new iterated configuration from 522 using a console at 523. A user may also proceed directly from opening a configuration using a console at 520 to drawing a digital iteration of this configuration using a console at 523. After drawing an iteration of a configuration at 523, a user may save the configuration at 511. This iterative cycle may continue indefinitely with the user opening the just saved configuration, or any other saved configuration at 520. Any individual user or group of users may save one or more configurations at 511. Any individual user or group of users may then proceed to share such configuration at 512; submit such configuration at 530; or open such configuration at 520. Referring to FIG. 12, in the case of shared iterations 1281B, the plurality of shared iterations may be collaborative designs in which more than one user is listed as the designer of an iteration, as may be seen in the version list 1280 of the design overview screen 1200. Once a best version of a configuration has been designed, a user or a friend group, may choose to submit this configuration for possible inclusion in the library, at 530, which corresponds to using the submit button 1263 of FIG. 12.

Now, referring to FIGS. 6-17, various embodiments of different screens of a mobile app for a mobile handheld device (such as an iPhone or an Android device) are shown. These are non-limiting examples of how the systems and methods of the present disclosure may appear on a console. The user interface screens on a mobile device are non-limiting exemplar embodiments which can be translated to other platforms such as a console game, laptop, desktop, AR or VR goggles, for example.

Now, referring to FIG. 6, an image of a non-limiting exemplary library overview screen 600 is provided. A screen title 601 may appear at the top of the screen, in this case saying “Library.” In some embodiments, a library overview screen 600 may present a scrollable series of configuration thumbnails 620A that may be viewed and scrolled through on a console 110 of FIG. 1. In some embodiments, a configuration thumbnail may be a graphic summary of a configuration which may include a name of the configuration and a perspective or other image that provides a visual preview of the configuration. Such scrollable series may include any number of configurations. In some embodiments, the library overview screen 600 may include providing one or more configuration thumbnails 620A, 620B that may be clicked on in order to open a configuration overview 800 such as the non-limiting example discussed in more detail below in reference to FIG. 8. In one embodiment, the library overview screen 600 may include a row of configuration thumbnails that may be scrolled from left to right to reveal a plurality of configuration thumbnails such as configuration thumbnail 620A and the thumbnails to the left and right of it, two of which extend beyond the screen to the left and right. The set of scrollable thumbnails in this row may be changed by choosing a filter menu 630 showing, in this case, the example filter of “Popular This Week.” In some embodiments a grid of thumbnails such as the 2×3 grid of thumbnails including thumbnail 620B may present a set of different configurations from which a user may choose. The thumbnails in this grid may be changed by choosing from a filter menu 631 a filter such as the example here of “Newest” which would provide configuration thumbnails for configurations which have been most recently made available from a database of configurations. In one embodiment, for sets of filtered results exceeding six, further results may be revealed by scrolling left or right by, for example, but not limited to a finger swipe or by pressing a left arrow 641 or a right arrow 642. In some embodiments the library overview screen 600 may include a search function 650 for searching contents of the configuration engine 201 or its databases 206, 207, 208, and 209 of FIG. 2. The search function could be used for pulling up sets of custom-filtered results querying various data associated with any one or more configurations. In some embodiments a bottom navigation bar may include tabs for navigating to different areas of the app such as a library tab 610, a friends tab 611, and a workshop tab 612.

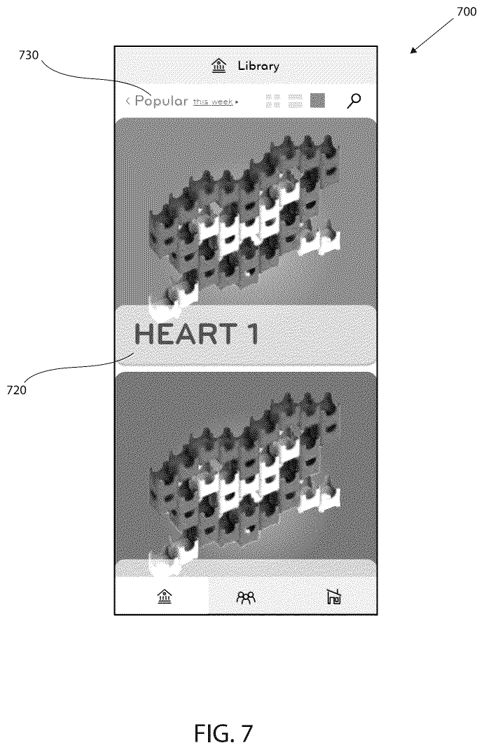

Now, referring to FIG. 7, an embodiment of a non-limiting exemplary library filter screen 700 is provided. This may include a filter menu 730, showing in this case the filter called “Popular this week,” which would use data from system 200 of FIG. 2 to populate the vertically scrollable screen with configurations thumbnails 720. A library filter menu 730 could present configurations with some commonality, such as configurations which use: the same sets to build, meaning sets of physical members that may be purchased and/or packaged together; or containing the same, or a similar number of modular members; or being of a similar subject matter such as flowers, robots, or butterflies, for example. In one embodiment, the library overview screen 700 (and other screens or pages of a mobile app) may include a navigation bar at the bottom including a tab for the library, a tab for friends and a tab for the workshop, for example.

Now, referring to FIG. 8, an embodiment of a configuration overview screen 800 is provided. The configuration overview screen 800, may include: a configuration view 890 such as a plan view or, in this case, a perspective view; a configuration title 835; a menu button 867, for pulling up other tools; a data list 871, which may include information such as the physical sets needed to construct the configuration; a further data list 872, which may provide the user other data concerning the configuration such as the number, type and color of members used; an open button 865; and a save button 866. The open button 865 may open a configuration instruction screen 900, such as the embodiment shown in FIG. 9. The save button 866 may save the configuration to the user's own saved configurations 206 of FIG. 2. A user's saved configurations may include: existing approved configurations that have made it through the curation process and are included in the library of the app; edited versions of such approved configurations, edited by the user or other user; new completed configurations drawn by the user; and/or incomplete work-in-progress configurations by the user. Such saved configurations may be saved to the user's database of configurations 206 of FIG. 2.

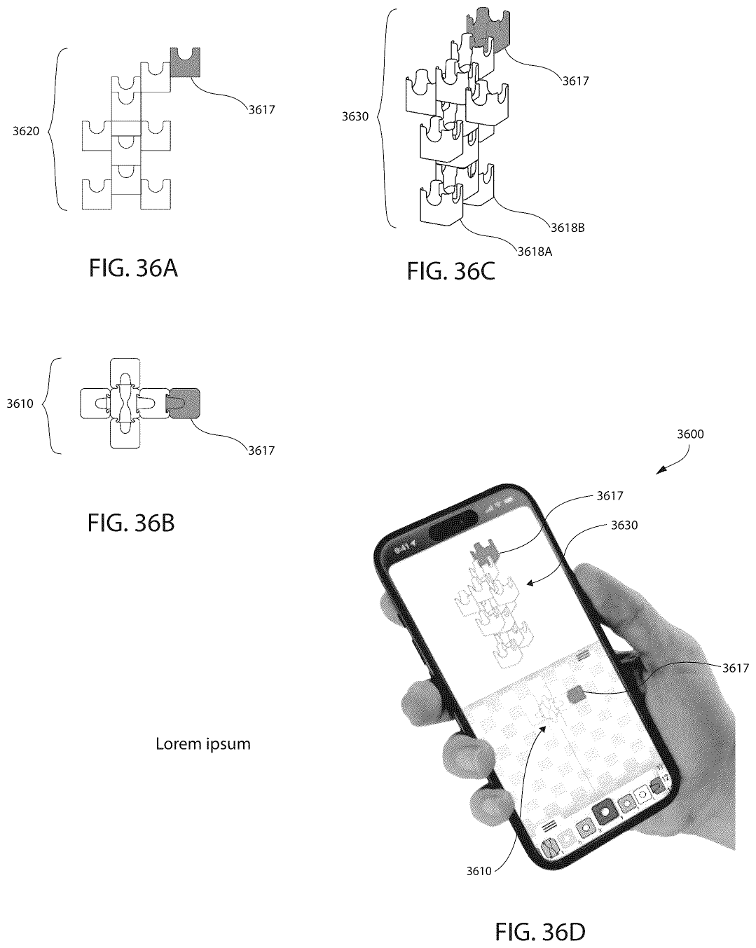

Now, referring to FIG. 9A, an embodiment of a non-limiting exemplary configuration instruction screen 900 is provided. On this instruction screen 900, a plan view 995 and a perspective view 990 of a configuration may be seen simultaneously. A back button 968 may return a user to the configuration overview screen 800 of FIG. 8. An adjustment tab 920 may allow the perspective view 990 to be pulled down varying amounts as discussed below in more detail in reference to FIG. 14 and the similarly functioning adjustment tab 1420. In some embodiments, another adjustment tab 922 may be pulled up to reveal various data about the configuration, such as for example, but not limited to: sets used; and number, color and type of members used. Using finger gestures on a mobile app screen, a user may scroll left and right (or, optionally, up and down) to change layers in the configuration in order to see successive layers of the configuration and how various members may be arrayed on each layer. Alternatively, a user may navigate from layer to layer of a configuration using a layer selection dial 951. How layers may function, including active and non-active layers, and how plan and perspective views may relate to one another on a screen is discussed in more detail below with reference to at least FIG. 36A-FIG. 36D and FIG. 37A-FIG. 37C.

In this non-limiting exemplary instruction screen 900, the layer selection dial 951 is set to layer 12, thus designating layer 12 as the current active layer. An exemplary plan view icon of a double-exit member 9951 is shown and rendered in this case in darker tones to highlight that it is a member of the active layer. An active layer, the layer currently viewed may be highlighted to distinguish it from other layers. Layers which are below the “active” layer, which have a lower vertical Z-dimension than the active layer may be rendered in a way that makes them less visually apparent so that the active layer members may stand out clearly.

FIG. 9B shows how adjustment tab 920 may be pulled to the top of the screen, thus hiding the perspective view 990 and increasing the screen space available for the plan view 995 and thereby extending the optional grid 980, which may span the plan view 995.

In some embodiments the configuration instruction screen 900 or other screen of the app may include links for suggested or related configurations that a user might want to follow next.

In another embodiment, the configuration instruction screen 900 of FIG. 9 or the configuration overview screen 800 of FIG. 8 may include an ability for a user to score a configuration along some continuum from easy to hard, or simple to challenging, for example. Or such a score may be between two choices such as either “easy” or “hard.” Or such a score may be three choice such as “easy,” “medium,” and “hard.” Analysis of a user's scores on various plans they build may be used to assist in recommending next configurations to try to build or in serving guided learning lessons. Such scores collected from a plurality of users may be used to assist in recommending next configurations and guided learning lessons to individual users. Such scores collected from a plurality of users may also be used by the curation engine 262 of FIG. 2 in evaluating new configurations in comparison with existing configurations. The analysis of results of users' scores on how hard a configuration is to build could help categorize individual users as beginner, intermediate, advanced, for example. The analysis of user's configuration difficulty scores could also be used to categorize the configurations as beginner, intermediate, advanced, or an analogous or related gradation.

Now, referring to FIG. 11, an image of a non-limiting exemplary workshop home screen 1100 is provided. The workshop portion of the app provides the user with functionality for drawing, saving, opening, editing, and iterating configurations of the members (which may also be called designs). Configurations of the members are discussed extensively below. In some embodiments, for general navigation: the workshop home screen 1100 may be accessed by selecting the workshop tab 1112 which may be at the bottom of a screen in some embodiments, the library home screen may be accessed by selecting the library tab 1110 which may be at the bottom of a screen, and the friends home screen may be accessed by selecting the friends tab 1111 which may be at the bottom of a screen, in some embodiments.

The screen title 1101 at the top of the workshop home screen 1100 may highlight the screen function. A guided learning tab 1115 for navigation purposes may appear on the workshop home screen 1100. An open new design button 1170 may open a blank configuration design screen 1400 of FIG. 14 with no members in any of the views of the design screen 1400, since upon first opening a new design, the user has yet to place any members in the new design. Various filter buttons may also appear allowing a user to also or instead open a partial or completed design or configuration. Design filters may be provided together with a small sample set of designs (or configurations) that meet the filter criteria. This non-limiting exemplar workshop home screen 1100 may provide, for example, but not limited to: a draft designs filter 1125A and design thumbnail 1120A among a sample set; a completed designs filter 1125B and design thumbnail 1120B among a sample set; a submitted designs filter 1125C and design thumbnail 1120C among a sample set; and a saved designs filter 1126 and design sample results 1121.

The workshop 1100 may be where a user organizes their own collection of configurations (which may also be called designs). Collected configurations may be organized into various categories such as: all draft configurations (or designs); all completed configurations (or designs); all submitted configurations (or designs); all saved configurations (or designs) which could be approved designs the user found in the approved configurations library and chose to save within their workshop for easy access or for editing and iteration at a later time; and all shared configurations (or designs). There may be a button for initiating a new configuration 1170 (or design). Pressing this new design button may open a design overview screen 1200 of FIG. 12.

In one embodiment, one or more design thumbnails 1120A may denote different configurations, and these may include a small perspective rendering 1128 of the configuration and a configuration name 1129 which may ease the ability to find one among many configurations. In some embodiments, a user may also be able to assign a name to a configuration. Selecting or clicking on one of these thumbnail images or buttons may open a configuration design overview screen 1200 which may also be called a design overview screen 1200.

Now, referring to FIG. 12, an embodiment of a non-limiting exemplary design overview screen 1200 is provided. In one embodiment, in order to manage iterations of a design (or configuration or draft configuration as designs may be considered throughout this specification), the design overview screen 1200 may include a version list 1280, or iteration list 1280, of related variations or iterations or other related designs or configurations. For example, if a user is making a design of a fish, it may take several iterations before the user feels that the best design of this fish has been achieved. Early iterations may be: tippy or unstable; or lack good marble flow; or lack good pathway design in the case the user is designing particularly with video game use in mind; or lack good deployment of color. As the user hones the design through successive iterations, older iterations may be saved in the version list. The version list may contain one or more, including, five or a plurality of designs or configurations.

In some embodiments, the design overview screen 1200 may include an edit button 1264 for opening a design and arriving at the configuration design screen 1400 of FIG. 14A for that design and the chosen iteration. Alternatively, a user may select a version from the version list 1280, highlight such a version and then click edit in order to edit that iteration or version of the design, such as iteration 1281B or iteration 1281E. Iterations in the iteration list may also be given names or titles. The overall design configuration may be named with a design title 1235 and thumbnail image 1290 may be chosen by the user or automatically selected from a version in the version list. The user may choose to edit any configuration that may be saved in this list whether or not it is considered an iteration, for it could be saved in the version list not as a version, but as a point of contrast, say a dog in the case of the user designing a fish and wanting to be able to make quick and easy access to a dog design they want to design the fish with respect to. A close button 1268 may bring the user back to the workshop home screen 1100 of FIG. 11.

In some embodiments, the design overview screen 1200 may include a submit button 1263 for submitting a configuration for possible inclusion in the library. Selecting the submit button may be one way in which a user could initiate the process in which their design could be evaluated in the curation engine 261 of FIG. 2.

In some embodiments, when a user has chosen to share a design with a friend(s), the version list may be used for listing versions designed by the user and by friends. Used in this way, the version list may become a tool for assisting in a collaborative design process. When a design is submitted to the library, in some embodiments, only a chosen best iteration is submitted for review. The user who initiated a design by pressing the new design button may be the default manager of that design. Friends with whom the design is shared, friends invited to collaborate on the design, may be guests on the design which is managed by the design manager. The role of manager may be transferred to another user. The design manager may manage the version list and the ordering of the designs in that list. When a design is submitted, the manager may select which one design among the various iterations is actually being submitted for curation. In some embodiments the various friend collaborators may vote on which design is best and should be submitted and such votes may be recorded as a means of selection of the favorite design of the group rather than just the favorite design of the manager.

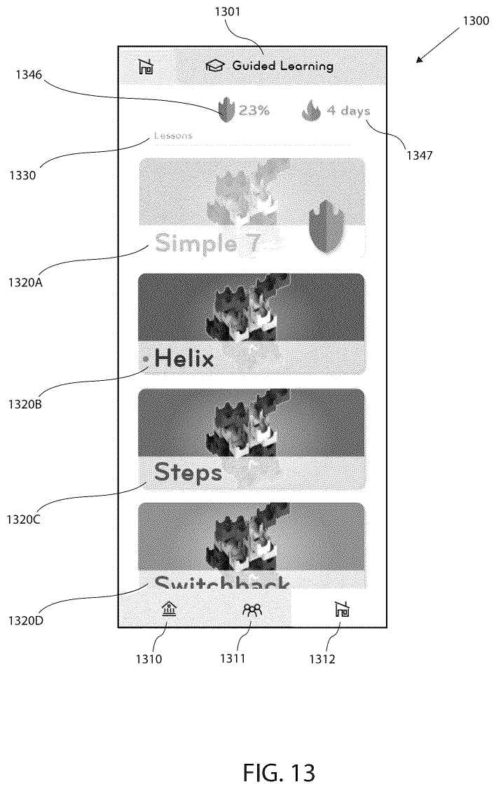

Now, referring to FIG. 13, an image of a non-limiting exemplary guided learning home screen 1300 is provided. Guided learning may have various series of lessons that assist a user with learning to, for example, but not limited to: build with the real-world modular members; follow the virtual instructions screens; follow printed instructions sets; design or iterate new configurations. In some embodiments, data about a user may be kept in order to track their progress. These lessons may be available by clicking on one, or a plurality of lesson thumbnails such as lesson thumbnails 1320A, 1320B, 1320C. Data from guided learning may be used to assist in making recommendations on the next configurations a user may want to build. Or data from guided learning may be used in conjunction with efforts by a teacher, for example, or other leader to assign appropriate challenges to a student. A library tab 1310, a friends tab 1311 and/or a workshop tab 1312 may assist navigation to the other screens of the app.

In some embodiments, guided learning may be accessed via a link or tab from one or more of the other screens of the app. Guided learning may be context dependent so when it may be accessed from an instruction screen the lessons may be associated with using instructions, or when accessed from a design screen the guided learning may be associated with skills helpful in designing. A user may use a search menu to find guided learning lessons or use the filter menu 1330 to find lessons to follow.

As a non-limiting example, guided learning lessons may be suggested by one of the engines of FIG. 2, such as the spatial reasoning engine 281. Guided learning challenges may be constructed that connect language and spatial reasoning by making verbal prompts for spatial responses and vice versa. Guided learning lessons may present challenges such as: “make a new configuration using a simple seven base, two 3-member cascades and one 8-member helix;” or “see how many sub-configurations you can find in this configuration” and the user responds, for example with “one cascade, one helix, two zigzags.” Tests may also be developed by the system as guideposts to track user development over time as they progress through the guided learning lessons. The guided learning screen may include a learning dashboard with such metrics as progress percentage 1346 or participation streak 1347.

Now, referring to FIGS. 14A-14D, an embodiment of a non-limiting exemplary configuration design screen 1400 is provided. This may also be called a design screen 1400. In order to record a physical configuration a user may have designed, a user may use the configuration design screen 1400 to draw or record a digital configuration of this physical configuration on a screen of a mobile handheld device (see also FIG. 36D). A user may also design a digital configuration directly onto a handheld mobile device by imagining the configuration rather than referencing a physical configuration of members. Once recorded, a user may build a physical configuration of members by following layer-by-layer instructions of this recorded design, either while viewing the design in the configuration design screen 1400 or by viewing the design in the configuration instruction screen 900 of FIG. 9.

A distinction between a configuration instruction screen 900 of FIG. 9 and a configuration design screen 1400 of FIG. 14 may be that the configuration instruction screen 900 lacks a parts or member menu at the bottom of the screen. In one embodiment positional information, or x, y, z coordinate information may be entered by the user, not by typing in values for x, y, z, but by sliding member icons 1480B out onto a checkerboard grid of a plan view 1440 of a layer of a configuration. In some embodiments, a menu 1460 of members at the bottom of the design screen 1400 may be scrolled from left to right and right to left. Many member types and colors may be presented with the impression that the scroll extends beyond the screen to the left and right. The scroll may optionally be a loop such that the entire list may repeat by scrolling only to the left or only to the right. A plurality of member icons may appear on the menu such as double-exit member plan view icon 1480A, or bottom-exit member plan view icon 1480C. A user may load the menu 1460 with a finite number of members corresponding to the number of such members provided in one or more sets of physical members one may purchase. A member icon may include a subscript number 1481 showing how many of that member, or how many of that member in a particular color remains available out of an original number of such members loaded into the menu 1460. In some embodiments, as the menu 1460 is scrolled left or right, the member icon in the middle may be highlighted such as by being magnified in size, or gaining a drop shadow, or shifting upward partly onto the checkerboard grid of the plan view 1440. Such a highlighted member 1480B may thus become available for a user to slide out onto the checkerboard grid for placement on the design, such as by using a finger gesture on the screen.

In the plan view 1440, in some embodiments, the screen may be rendered with a checkerboard grid. Alternating squares in the grid may be white squares 1447A or gray squares 1447B (these squares may optionally be other colors than white or gray). In some embodiments, due to the half member height shift from layer to layer (which may be a result of how the side joinery connects horizontally adjacent members), on any particular layer, only half of the checkerboard squares may accept a member. If, for example, members may be placed in white squares, but not on gray squares, for an odd numbered layer, such as layer 1, 3 or 7, then for an even numbered layer, such as 2, 4 or 8, members may be place only on the gray squares and not the white squares.

Different layers of a configuration may be accessed in some embodiments via a numbered scroll wheel 1430, numbered for each horizontal layer of a configuration. A scrollable menu 1430 of parts may be on the bottom of the screen with symbols for various members of a set 1480A. A user may load a set or multiple sets in order to populate this scrollable menu with members or parts of a set (such as a set of physical members that can be purchased online or in a store). Alternatively, a user may make a custom set with any number of members user would like to include. A small number 1481, optionally as a subscript or superscript, may be next to the member or part symbols as a means of signaling to the user how many of that member in a particular color remains available out of the chosen set or sets. In some embodiments this number could be allowed to go negative as a signal that more pieces beyond the selected set are needed, without stopping the user from continuing to add more parts. Or the availability alternatively could be set to stop when the parts or members of the chosen set or sets runs out as a way to force the user to work within the given constraints.

In some embodiments, the design screen 1400 may present two iterations or two configurations at the same time. For example, a configuration 1A may appear as a 3D perspective above, below or beside a configuration 1B. Alternatively, a configuration 1A may be superimposed on top of a configuration 1B. Either of the superimposed configurations may be rendered as a lighter or ghosted rendering so that there is a hierarchy in which one of the configurations is more visually apparent.

In some embodiments, there may be a painter tool available on the design screen 1400 which allows a user to change the color of members in one or more of the plan, section, elevation or perspective views and for that color change to migrate through to all views. In some embodiments, a painter tool may be available in a configuration instruction screen 900 of FIG. 9.

In some embodiments, a tool may allow a user to swap the colors of all or a subset of all members. For example, in an iteration with red members, such as red single-exit members and red double-exit members, a user could choose to swap out red for green, in which case the iteration would now have green single-exit members and green double-exit members where it previously had red versions of those members.

In some embodiments, there may be a color redistribute tool. This tool may be set to randomly distribute the colors in a configuration using any colors or, alternatively, using the available colors of the configuration, or the available colors of a set or a plurality of sets, or the available colors as designated by the user or a game the user is playing. Alternatively, the color redistribute tool, instead of randomly reassigning colors, could assign colors based upon some constraint, such as a color gradient, which could specify, for example a progression from yellow to blue to green to red from top to bottom or left to right across a configuration.

In some embodiments, the positional data, the x, y, z, data, the member rotation data and other member-related data may be entered by the user on the design screen 1400 as described above and then processed and saved by the configuration engine 201 of FIG. 2.

Now referring to FIG. 14C, in some embodiments a 3D perspective or isometric rendering 1452, in for example, a perspective or isometric view 1450, may be simultaneously viewed on the design screen 1400 together with a plan layer 1453 on the plan view 1440. The design screen 1400 may provide for varied positions of a pull-down tab 1420 to allow the isometric view 1450 to take up more or less of the overall design screen 1400. In FIG. 14B, the pull-down tab 1420 is at the top of the screen, thus fully revealing the plan view 1440 and the checkerboard grid. In FIG. 14C, the pull-down tab 1420 is pulled halfway down so there is a mixed 2D/3D view. In FIG. 14D, the pull-down tab 1420 may be pulled all the way down, so the perspective view 1450 fills the screen.

In some embodiments, dragging member icons 1480A, 1480B onto the perspective view 1450 provides the ability to place members directly on the 3D rendered view 1452. A member placed on the 3D rendered view 1452 may then automatically populate the appropriate layer in the plan views with the plan view symbol for that member.

In some embodiments, a layer selection dial 1430 may allow a user to navigate up and down the layers of a design, whether the layers are populated with members or not. This layer wheel may have similar functionality to the layer selection dial 951 of FIG. 9. Some embodiments may allow navigation from layer to layer by, for example, but not limited to finger gestures on the design screen 1400.

In some embodiments, whether in a plan or perspective view, members of the active layer on which members may be placed may be highlighted, such as by being rendered with deep colors 1445, 1455. Members that are below the active layer, whether in 3D view or plan view may be rendered as outlines only or tinted with white, for atmospheric perspective, as if there is a haze or cloud making them appear lighter 1446, 1456.

In some embodiments, when a plan symbol 1480B is dragged onto the plan grid and placed, the corresponding 3D rendered view representation of that member appears. In other embodiments, the member symbol in the menu 1460, may be an isometric or perspective symbol. In some embodiments, a member may be placed on an upper layer, such as layer 12, without having supporting members below. Alternatively, a rule may be set that there can be no such floating members, thus forcing the user to build from the bottom up, always providing support for members from below.

In some embodiments, a contextual menu may appear on the configuration design screen 1400 to provide tools for a user to input or adjust details such as object rotation and color.

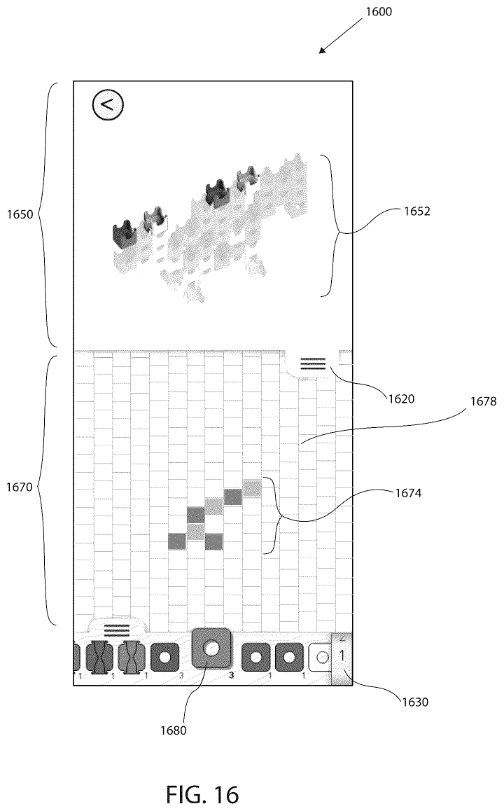

Now, referring to FIG. 16, an embodiment of a non-limiting exemplary configuration design screen 1600 is provided in which an elevation or section view 1670 is seen together with a perspective view 1650. In some embodiments, an elevation view 1670 or section view 1670 and a plan view, such as plan view 1440 of FIG. 14A, may be seen at the same time on the design screen 1600. In some embodiments, plan, section, elevation and/or 3D views may be seen at the same time on the design screen 1600. In some embodiments, in the elevation or section view 1670, the screen may contain a shifted grid 1678 in which stacked columns of squares may be offset by one half the height of a square every other column. This shifted grid accounts for the half-step offset between some of the horizontally adjacent physical members in this construction system. An elevation or section layer 1674, may appear in the section view 1670 and members may be added to this layer by dragging them out onto the section view 1670 from the menu below. In some embodiments, a layer selection dial 1630 may be used to move the section cutting plane forward or back in order to reveal members which may be covered by intervening section layers.

Now, referring to FIG. 17A and FIG. 17B, an embodiment of a non-limiting exemplary design screen 1700 is provided. The plan view grid 1780 of this design screen 1700 may be interactive, such that a user touching and rotating the grid may cause a corresponding rotation of the perspective view 1752 which may be above the plan view 1753. A layer one member 1731 and a top layer member 1732, may be compared between FIG. 17A and FIG. 17B to appreciate how this view rotation works. In some embodiments, for example, finger gestures on the screen lead to the rotation of the views. In one embodiment, rotating the perspective view also rotates the plan view. The seven members with the darker outline are in a “simple seven” base configuration. The four members on higher layers than the first seven members are outlined in a lighter gray and are in a cascade formation, cantilevering out from the “simple seven” base.

FIG. 18A, FIG. 18B, FIG. 18C and FIG. 18D provide embodiments of: a virtual pathway module 1810; a modular member 1821 with a virtual pathway module 1810 superimposed inside of it forming a superimposed member 1820; a primitive 1860 which in some embodiments is a cube; and a primitive 1860 bounding a virtual pathway module 1810 superimposed inside of it.

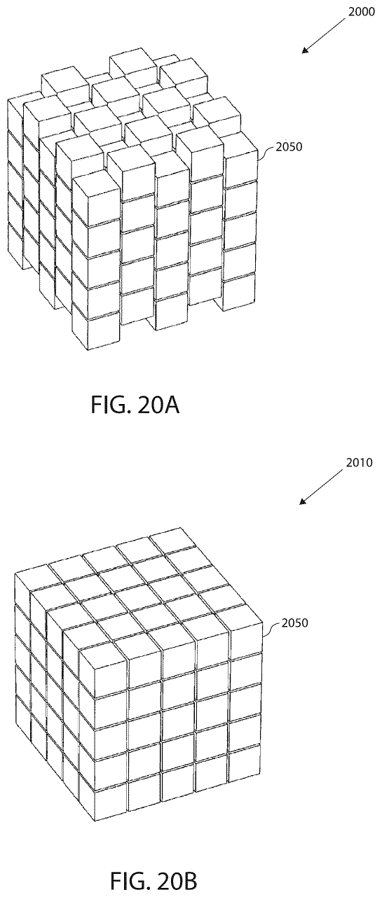

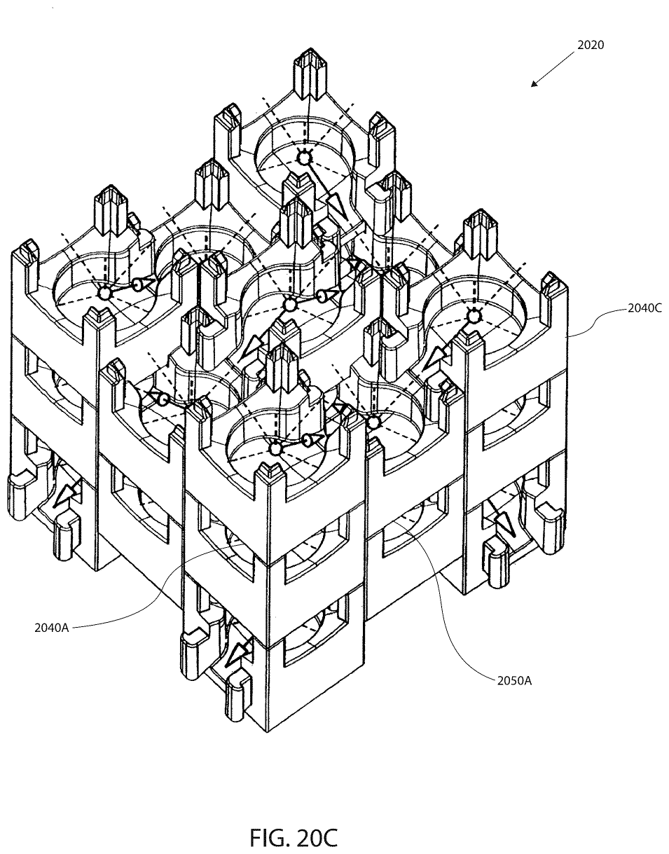

Configurations of modular members may be drawn or rendered with primitive members 1860, for example the configuration 2000 in FIG. 20 with primitive 2050. Configurations of modular members may also be drawn or rendered in greater detail resembling actual physical modular members as in configuration 2100 of FIG. 21. The virtual pathway module 1810 comprises: a core node 1845; an exit node 1846; side entrance links 1840A, 1840B, 1840C and 1840D; top entrance link 1841; and exit link 1842. In some embodiments, there can be a plurality of entrance links and exit links (greater or fewer than illustrated in the virtual pathway modules 1810).

In one embodiment, primitives 1860 which may be cubic may stand in for virtual pathway modules 1810 or modular members 1821. In some embodiments a primitive may be a six-sided polygon.

Now, referring to FIG. 18E, in one embodiment, four single-exit superimposed members 1820A, 1820B, 1820C and 1820D, may be interlinked into a cascade pattern 1880. The virtual cascade pathway 1881 directly corresponds to the cascade pattern 1880 of the modular members. Cascade pathway 1881 is what remains of cascade pattern 1180 when the modular members 1821 are removed leaving just the linked virtual pathway modules 1810A, 1810B, 1810C and 1810D. The virtual cascade pathway 1881 is composed of four virtual pathway modules 1810. The exit node 1846 of each virtual pathway module 1810 may connect to an entrance link 1840 of the next connected virtual cascade module. The virtual cascade pathway 1881 includes multiple entrance links 1840 and 1841 that are not connected to exit nodes 1846 of another virtual pathway module. The virtual cascade pathway 1881 can therefore be diagrammed as a simplified virtual cascade pathway 1882 showing only the connected links and nodes. In the cascade pattern, the direction of entrance links 1840 and the direction of exit links 1842 may be aligned in plan view.

Now, referring to FIG. 18H, in one embodiment, four single-exit superimposed members 1820 may also be interlinked into a zigzag pattern 1890. Similar to the cascade example above, the virtual zigzag pathway 1891 of FIG. 18J directly corresponds to the zigzag pattern 1890 of the modular members. A simplified virtual zigzag pathway 1892 of FIG. 18K, illustrates the virtual zigzag pathway 1891 with the unconnected entrance links removed. The direction of entrance links 1840 and the direction of exit links 1842 may be generally perpendicular in plan view.

Such cascade, zigzag and other patterns may be used as search criteria by the search engine 241 of FIG. 2.

Any hand-drawn or computer-drawn representation of a physical configuration such as of the modular members in the zigzag pattern 1890, is not the physical configuration itself, but a representation. This representation is a 3D rendering generated by a computer from a 3D computer aided design (CAD) file. In FIG. 18H, the representation of the physical zigzag pattern 1890 is a 3D computer rendering in which an outline style of rendering was chosen. Other rendering styles may include photo-realistic, phong, cartoon and other styles. The virtual world engine 211 and/or the rendering engine 221 may produce renderings in various visual styles. These renderings may be used as graphics in the display device 116. Non-limiting examples of such 3D renderings for a user console include the 3D rendering of FIG. 35E and the 3D rendering of FIG. 36C.

In one embodiment, a function of the configuration engine 201 of FIG. 2 may be keeping track of the plurality of possible virtual pathway configurations in terms of the relationship of core nodes 1845, exit nodes 1846, entrance links 1840, exit links 1842 and/or which entrance links 1840 of one virtual pathway module 1810 meet the exit nodes 1846 of another virtual pathway module 1810.

In some embodiments, the physical modular members may be purchased in various sets with differing numbers, types and colors of modular members. For example, the Big Box set may contain thirty-six modular members: eighteen single-exit members, nine bottom-exit members and nine double-exit members. The members may be in a mix of colors such as red, green, blue, yellow and clear.

In one embodiment of the mobile app (which may also be a console game), a user may choose one or a plurality of sets including modular members. The configuration engine 201 of FIG. 2 may keep track of the total number of members in the user's collection, as well as keeping track of how many members remain available as a user may place members into a configuration using a design screen 1400 of FIG. 14. A user may specify the sets the user owns or wants to be constrained to when working on a configuration design. In some embodiments a user may choose to have the member colors shown, or to work in gray scale, or to work with no colors specified at all such that all members have one shared color (or colorless) depiction.

In one embodiment the configuration engine 201 of FIG. 2 calculates how many sets are needed to build a configuration.

FIG. 19A through FIG. 19F provide embodiments of six virtual pathway modules 1900 showing six different entrance/exit patterns: single-exit pathway module 1910; double-exit pathway module 1920; L-exit pathway module 1930; tri-exit pathway module 1940; quad-exit pathway module 1950; and bottom-exit pathway module 1960. These virtual pathway modules may correspond to physical modular members as described in U.S. Pat. No. 8,475,226 B2, which is incorporated herein by reference in its entirety. In this embodiment, the six virtual pathway modules 1900 each have a core node 1945, five entrance links 1940 and 1941, and are differentiated by their exit links 1942 and exit nodes 1946. The six virtual pathway modules include: a single-exit virtual pathway module 1910, with one exit link and exit node; a double-exit virtual pathway module 1920, with two exit links and two exit nodes out opposing sides; an L-exit virtual pathway module 1930, with two exit links and two exit nodes on neighboring sides; a tri-exit virtual pathway module 1940, with three exit links and three exit nodes out three sides; a quad-exit virtual pathway module 1950, with four exit links and four exit nodes out four sides; and a bottom-exit virtual pathway module 1960, with one exit link and one exit node out the bottom. The six virtual pathway modules may also be considered pathway modules or pathway diagrams that illustrate in a generic way, how marbles may flow in a configuration of members no matter the specific physical form (or CAD polygon form) of the members in the configuration. Referring to FIG. 18B, the form of the member 1821 may be substituted with a different form, while still providing a geometry that provides the exit and entry pattern of the (virtual) pathway module 1810.

In one embodiment of the present disclosure, systems and methods may include just the six member types of modular members and virtual pathway modules 1910, 1920, 1930, 1940, 1950 and 1960. While seemingly constrained by this small number of basic member types, there is a huge universe of possible combinations of the digital and physical members in this embodiment. To put a number on it, just thirty-six single-exit modular members in five colors (for example, 6 blue, 6 red, 6 yellow, 6 green and 12 clear), interconnected to always make a single continuous pathway from one member to the next, not allowing any converging or diverging pathways, may be connected in 8.5×1041 combinations. When discontinuous paths are allowed as well, such that any of the 36 single-exit modular members may be vertically stacked, they may be connected in 2.9×1052 combinations. Add in any of the other five modular member types, allow converging and diverging pathways, and allow more than just thirty-six members, and there is a further exponential increase in the possible combinations. As a point of comparison, a Rubik's Cube may be scrambled in 4.3×1019 combinations. It will be understood that in other embodiments of systems and methods of the present disclosure, not such limit may be imposed.

An aspect of embodiments of the present disclosure may pertain to managing within this huge expanse of possible configurations and providing tools for users to design, draw, view, save, share, build, search, iterate, collaborate and more as a user(s) play and experiment with the modular members in the real and virtual worlds, both physically and digitally. These tools may assist in creating, finding, saving and sharing the best combinations within the more than 2.9×1052 possible combinations.

FIG. 20B provides 125-cube aligned configuration 2010 in a 5×5×5 arrangement in neatly aligned rows and columns in which the cubes all meet with faces and edges aligned. These cubes may be primitives 1860 as shown, for example, in FIG. 18D. FIG. 20A provides a 125-cube vertically shifted configuration 2000 of in which every other column (or vertical stack) of five cubes is shifted up one half a cube height. Any member 2050, may have ten adjacent neighbor members 2050: one neighbor member directly above, one neighbor member directly below, four upper neighbor members around the four faces, and four lower neighbor members around the four faces, each of these upper and lower neighbor members themselves stacked one on top of the other. FIG. 20C provides a non-limiting exemplary 23-cube vertically shifted configuration 2020 which is a subset of the 125-cube vertically shifted configuration 2000. This configuration 2020 is an example demonstrating how an interior member may have ten such adjacent neighbors as described above. This configuration 2020 also shows a corresponding virtual pathway threading through the modular members.

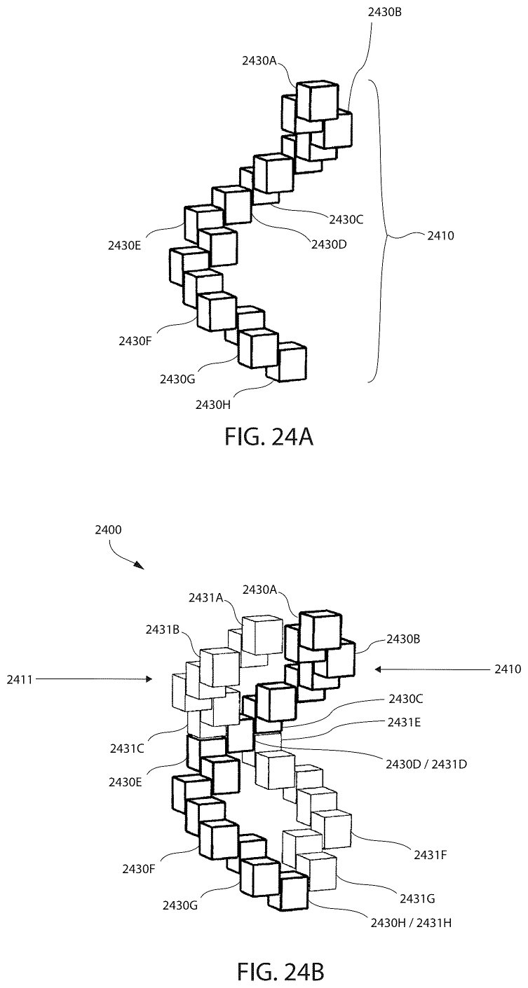

FIG. 24A shows a 16-cube helix 2410. These cubes may be primitives 1860, as shown, for example in FIG. 18D. The helical arrangement comprises alternating runs of cascade and zigzag patterns of successive cubes. Cube 2030F is at the bottom of a cascade of three cubes. Cube 2030F is at the top of a zigzag of four cubes terminating in cube 2430H. With reference to FIGS. 18A-18H, it will be appreciated that the primitives may be replaced with virtual pathway modules 1810 and thus form a helical virtual pathway configuration. Looking down from the top, a marble descending this 16-member helix 2410 would travel counterclockwise. The 16-member counter-clockwise helix 2410 is repeated in FIG. 24B and intertwined with a mirrored copy of itself in the 16-member clockwise helix 2411, forming intertwined helix 2400. The two helixes intersect at member 2430D, 2431D and again at member 2430H, 2431H. Intersecting member 2430D, 2431D, has four immediate adjacent neighbor members in the same pattern as member 2650A of FIG. 26, and can therefore be a double-exit member and substituted with a double-exit virtual pathway module 2620A as in FIG. 26B.

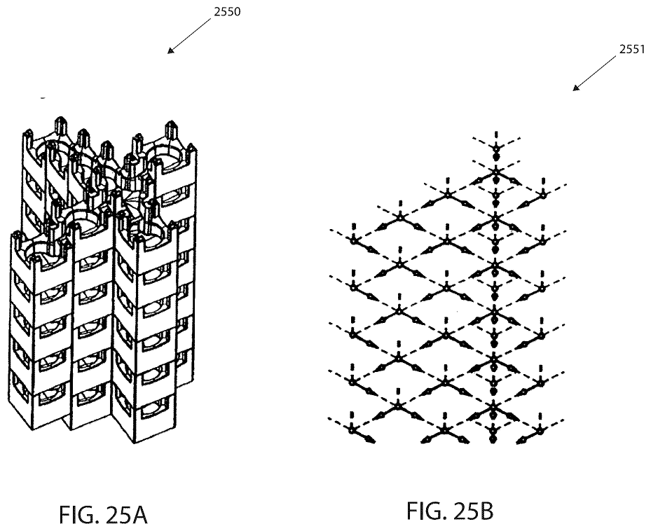

FIG. 25A provides a cruciform configuration 2550 of cubic members and an elevation view of the cruciform virtual pathway graph 2551 of this cruciform configuration.

FIGS. 26A-26F show one non-limiting exemplary configuration 2600 of ten modular members with a virtual pathway 2660 nested inside, in one embodiment. Two single-exit members, member 2640A and member 2640C have pathways leading into double-exit member 2650A. Double-exit member 2650A has pathways leading into two single-exit members, member 2640B and member 2640D. This same arrangement can be seen in the virtual pathway 2660 wherein two single-exit pathway modules, module 2610A and module 2610C, have exit nodes 2646 connecting to double-exit pathway module 2620A. Double-exit pathway module 2620A has exit nodes 2646 leading to two single-exit pathway modules, module 2610B and 2610D. FIG. 26C provides one single-exit virtual pathway module 2610. FIG. 26D provides one double-exit virtual pathway module 2620. FIG. 26E provides a plan view of the ten-member configuration 2601 showing only the modular members without the nested virtual pathways. This plan view shows how a marble pathway flows from the two single-exit members, member 2641A and member 2641C, into double-exit member 2651A. FIG. 26F provides a section view of the ten-member configuration 2601. The section cut goes through five of the members: member 2641A, member 2641C, member 2651A, member 2641B and member 2641D. Amarble rolling through this configuration and entering single-exit member 2641A rolls along the floor of member 2641A and falls into double-exit member 2651A and lands upon the floor of member 2651A. The marble may exit double-exit member 2651A to the left or right continuing into either single-exit member 2641B or single-exit member 2641D. The exit pathways out of these two lowest single-exit members are into the picture plane—as can be appreciated by examining the exit node 2646 of pathway module 2610B in FIG. 26B.

Configuration 2600 of FIG. 26A is a partial structure for illustrative purposes, which would need more members added for greater balance and stability in use with marbles rolling through from member to member when built as a physical structure.

FIG. 26A demonstrates several attributes of how the members and the virtual pathways relate: a first member 2640A has a pathway leading into a second member 2650A and second member 2650A has a pathway leading into a third member 2640B; and the first member 2640A is stacked directly on top of the third member 2640B. FIG. 26B accordingly demonstrates the same relative arrangement for the virtual pathway modules: a first virtual pathway module 2610A has an exit node 2646 that links to a second virtual pathway module 2620A and second virtual pathway module 2620A has an exit node 2646 that links to a third virtual pathway module 2610B; and the first virtual pathway module 2610A is above the third exit pathway module 2610B. Virtual pathway module 2610 of FIG. 26C and virtual pathway module 1810 of FIG. 18A are exactly the same virtual pathway modules just provided in two different figure drawings. FIG. 18B demonstrates how virtual pathway module 1810 nests inside of single-exit modular member 1821. The way double-exit virtual pathway module 2620A nests into double-exit modular member 2650 is the same as how single-exit virtual pathway module 2610A nests into single-exit modular member 2640A, with the only difference being the additional exit pathway in the double-exit member. FIG. 20A demonstrates how primitives 2050 stack in a vertically shifted configuration 2000. The three members (member 2640A, member 2650A, and member 2640B) are arranged in such a vertically shifted configuration. These three members may be substituted with primitives as demonstrated by the FIG. 18A and FIG. 18B. Any of the 125 primitives 2050 of the 125-member configuration 2000 of FIG. 20A may be substituted with any of single-exit pathway module 1910, double-exit pathway module 1920, L-exit pathway module 1930, tri-exit pathway module 1940, quad-exit pathway module 1950, or bottom-exit pathway module 1960 of FIG. 19A through FIG. 19F.

A close comparison of configuration 2020 of FIG. 20C and configuration 2600 of FIG. 26A provides an example of how module positions such as those illustrated in the 125-member configuration 2000 of FIG. 20A can be swapped with members of any of the six exit patterns shown in FIG. 19A through FIG. 19F. The three members—member 2640A, member 2640C and member 2650A of FIG. 26A—are positioned, relative to one another, the same as the three members—member 2040A, member 2040C and member 2050A. While the middle member 2650A of the three named above configurations 2600 is a double-exit member, the middle member 2050A of the three named above in configuration 2020 is a single-exit member. This demonstrates that a single-exit member may be swapped with a double-exit member (and vice versa) in a vertically shifted configuration such as configuration 2000 of FIG. 20A. Also, these pathway patterns may be defined by either the nodes and links of the virtual pathway modules or by the constraints of the geometry of modular members whether these are physical or digital modular members.

In one embodiment, a plurality of virtual pathway modules of FIG. 19A through FIG. 19F when linked may form virtual pathway graphs for use in the programming of video games, such as non-limiting exemplar graph 2660 of FIG. 26B.

Now, referring to FIG. 26B, in one embodiment, two or more player characters exploring a virtual pathway, pathway graph, or spaces with digital modular members may be near different core nodes, or in different spaces. For example, in virtual pathway 2610 of FIG. 26B, one player could travel down or up the left branch and the other down or up the right branch. Non-player characters (NPCs) descending the pathway may also travel left or right with the direction they travel being subject to chance either by the chance provided by calculations of the virtual world engine 211 or by the pathway engine 231 of FIG. 2. For example, it would be possible for half of the NPCs to travel down the left branch (which includes virtual pathway module 2610A) and half of the NPCs to travel down the right branch (which includes virtual pathway module 2610C). It would also be possible for all of the NPCs to travel down just one of these two branches. In such a case, one player character would encounter all of the NPCs while the other player character would progress without such encounters. Depending on the game rules, encountering the NPCs or not, may or may not be advantageous. The pathways and the randomization introduced by the branching pathways introduces an element of luck in a videogame.

In one embodiment, the dwell time of an NPC in a space or at a core node may be calculated all or in part by arrival time at the entrance link or core node. Or dwell time may be calculated all or in part by velocity at arrival to the entrance link or core node. Or dwell time may be calculated all or in part by the differential in the horizontal direction of the entrance link with the one or more exit links exiting away from the core node. Dwell time may be calculated with the pathway engine 231 of FIG. 2.

When the pathways are just links and nodes, this frees the visual expression of the spaces within the video game from the strict geometry of the physical cubes and allows creative interpretations like each node being a cloud in the sky, or the pathways being roadways with intersections and a driver being able to drive up or down the pathway network and to continue straight or turn at nodes as the orientation and entrance and exit patterns of the pathway modules allow. In the example of using the pathway network for a car racing game, the Z or vertical dimension of the pathway network could be significantly compressed compared to the X and Y or horizontal dimensions of the pathway network to create more of a gently rolling terrain, if preferred over the steeper terrain when each module fits in a cube of equal X, Y and Z dimensions. In other words, for a car racing game the cubic dimensions of the module could be wholly or partially flattened. The cubic dimensions could also be stretched or distorted. In these ways, the cubic module can be transformed into a rectangular or trapezoidal module of varying proportions to adjust the pathway network in ways appropriate to the slopes of roadways for car or other vehicle racing, including for planes, rockets and other non-wheeled vehicles which may be racing in the air or in space as opposed to on roadways or racetracks. The cubic dimensions may also be distorted evenly or unevenly so that the modules no longer hold to a strict orthogonal structure in which all of the vertices meet at 90 degrees and instead any vertices may meet at more or less than 90 degrees and be stretched or compressed in any ratio.

In one embodiment the Z-direction of the pathway graph may be collapsed such that entrances and exits of vertically offset pathway modules reside on the same horizontal plane.

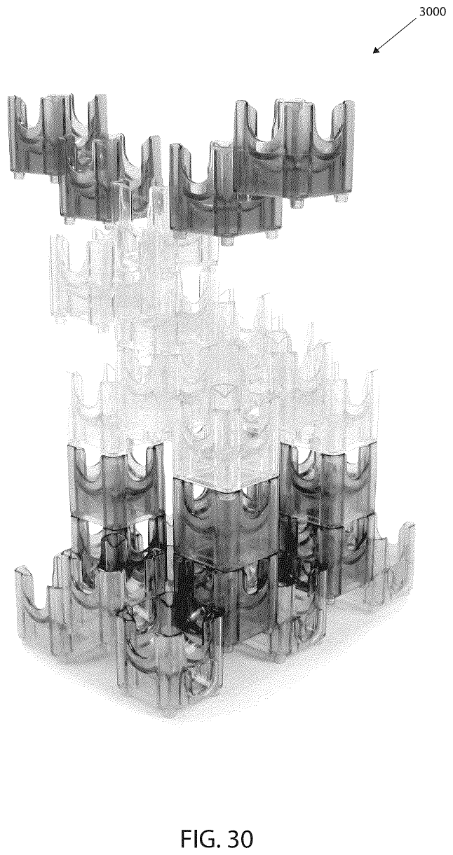

Now, referring to FIG. 30, a configuration in the form of a moose 3000 is provided. This is a photograph of interconnected modular members.

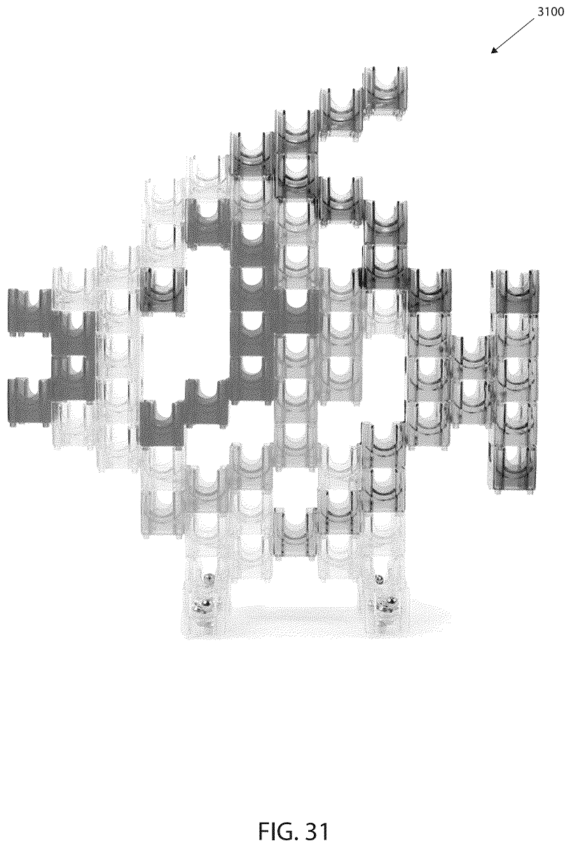

Now, referring to FIG. 31, a configuration in the form of a fish 3100 is provided.

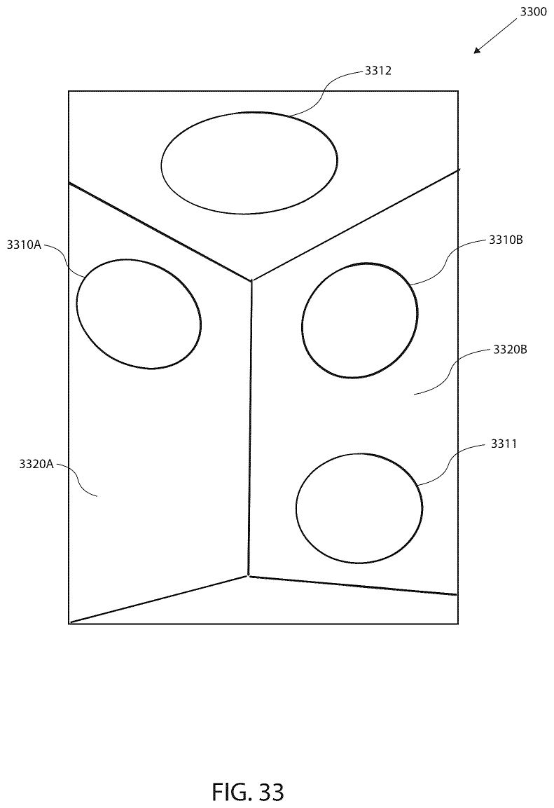

Now, referring to FIG. 33, a non-limiting diagrammatic exemplar interior perspective view 3300 is provided of the interior of virtual modular member 2640D of FIG. 26A. The ellipses 3310A, 3310B, 3311, 3312 (or circles) on the walls or ceiling represent entrance openings or exit openings into and out of the member. Two walls are shown, wall 3320A and wall 3320B. Wall 3320A includes an opening 3310 in the upper half of the wall. Wall 3320B shows an opening 3310B in the upper half of the wall and another opening 3311 in the lower half of the wall. The ceiling includes an opening 3312. In a video game with rolling marbles as non-player characters, opening 3310A, opening 3310B and opening 3312 may serve as entrances into this member, into the inner chamber defined by the bounding walls, and opening 3311 may serve as an exit out of the chamber of the member.

Opening 3310A, in wall 3320A, corresponds to the pathway leading from member 2650A of FIG. 26A into member 2640D. Opening 3310A further corresponds to the position of exit node 2646 of virtual pathway module 2620A of FIG. 26B with an entrance link of virtual pathway module 2610D of FIG. 26B.

Opening 3311, in wall 3320B corresponds to the position of exit node 2646 of virtual pathway module 2610D of FIG. 26B. In configuration 2600 of FIG. 26A, no exit nodes of any pathway modules align to opening 3310B in wall 3320B, or to opening 3312 at the top of member 2640D, though in other configurations, each of these entrance openings could be aligned with other members and virtual pathway modules such that exit nodes would be aligned.

Modular member 2640D of FIG. 26D is a single-exit member, but it could be substituted with a double-exit member, an L-exit member, or a tri-exit member as each of these member types has at least one wall with no lower exit opening (like wall 3320A) adjacent to a wall with both an entrance opening and an exit opening (like wall 3320B).

Entrance opening 3310B and exit opening 3311 in wall 3320B may also be expressed as a unified opening—a single opening allowing both entrance and exit.

For the purposes of a video game, modular members may be rendered as if they are the injection molded parts of the physical marble run shown in FIG. 30, but the members could be depicted in any number of ways, for example, such that the chambers of the members resemble rooms of a stone castle and the exits and entrances (such as opening 3310A and opening 3311) are doors and windows through the stone walls. In another embodiment, the opening could be depicted as an object such as a painting hung on the wall in a videogame.

In another embodiment, the modular members may not appear in a videogame and instead virtual pathway may be used without reference to the physical nature of the modular members. A racing game, such as a car or rocket racing game may use the virtual pathway modules and virtual pathway networks or graphs in this way.

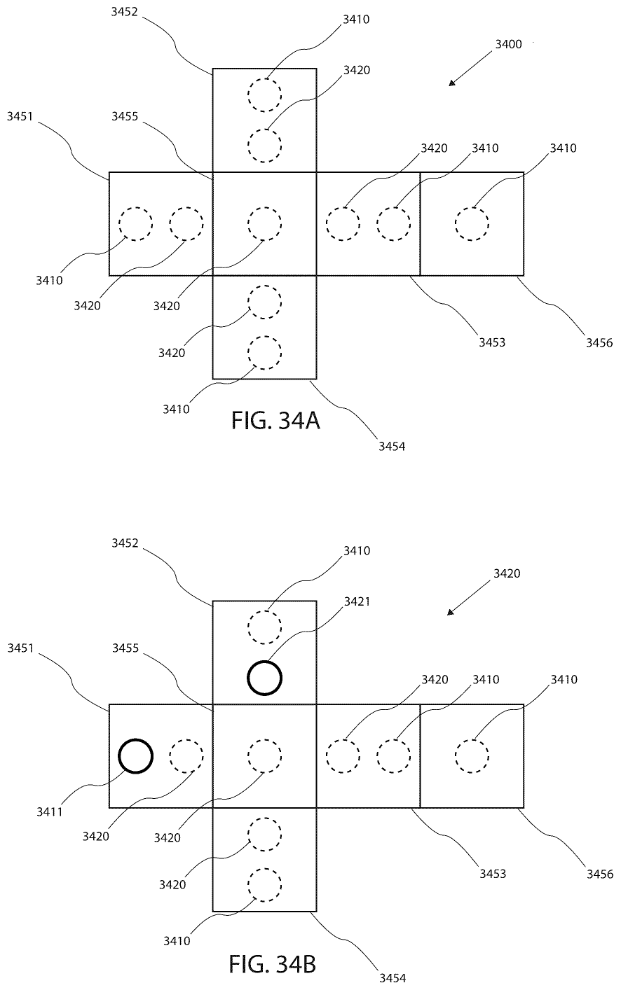

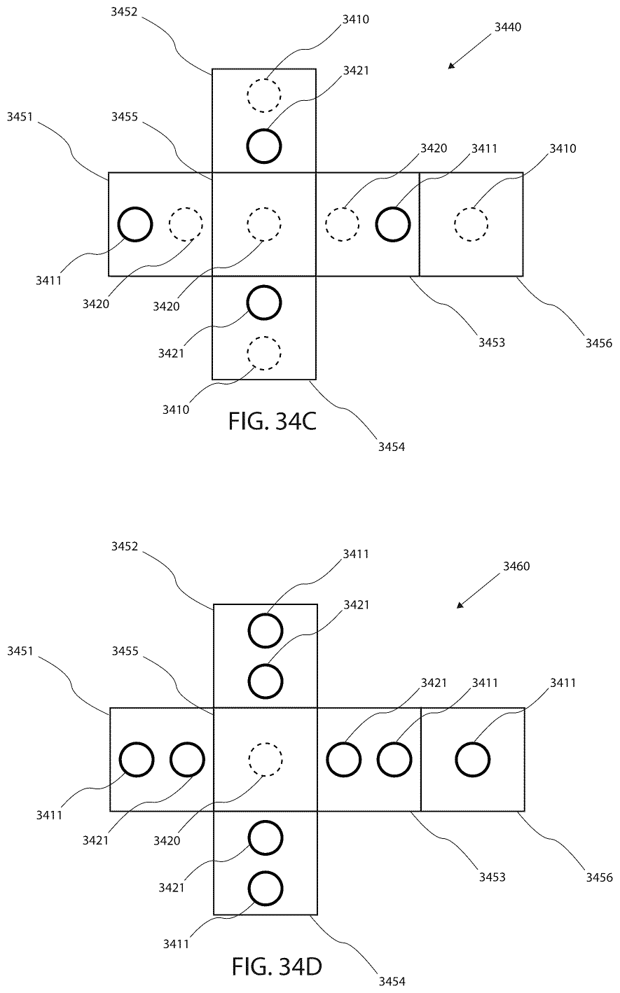

Now, referring to FIG. 34A, a non-limiting exemplary unfolded virtual modular member 3400 is provided in one embodiment. The member 3400 represents an unfolded cube laid out in a cruciform pattern. A first cube face 3451, a second cube face 3452, a third cube face 3453 and a fourth cube face 3454 surround a cube base 3455. A cube top 3456 is adjacent to cube face 3453. The folded version of this member 3400 is a cubic primitive like primitive 2050 of FIG. 20A, or primitive 2430A of FIG. 24A, or primitive 1860 of FIG. 18C. The entrance links and the exit node of virtual pathway module 1810 touch the top and sides of primitive 1860. Similar bounding primitives around any of virtual pathway module 1910 of FIG. 19A, or virtual pathway module 1920 of FIG. 19B, or virtual pathway module 1930 of FIG. 19C, or virtual pathway module 1940 of FIG. 19D, or virtual pathway module 1950 of FIG. 19E, or virtual pathway module 1960 of FIG. 19F may have side faces and top and base surfaces touched by the entrance links and exit nodes of these bounded virtual pathway modules. The unfolded modular member 3400 has circles representing locations on the faces, top and base where, when folded in cubic form, the entrance links and exit nodes of the virtual pathway modules may touch these faces, top and base. Entrance locations 3410 are denoted with dashed circles. Exit locations 3420 are denoted with dashed circles.

Now, referring to FIG. 34B, non-limiting exemplary unfolded modular member 3420 is provided. The difference between unfolded modular member 3400 and unfolded modular member 3420 is that two of the dashed line circles of modular member 3400 are replaced with solid line circles in modular member 3420. Entrance locations 3411 with solid line circles denote entrance locations which are paired with another module such that an exit node of the and entrance link have been paired, or, in other words that a connection of two modules has engaged this entrance. Engaged entrance locations 3411 and engaged exit locations 3421 may be mapped to corresponding entrances or exits in both digital and physical members by way of folding an unfolded modular member 3420 back into cubic form, and aligning the folded member to a virtual pathway module similar to 1870 in FIG. 18C. Unfolded modular member 3420, represents a member which is paired with two other members such that an engaged entrance 3411 and an engaged exit 3421 are on adjacent faces of the refolded member. Member 2640A of FIG. 26A is such a member. Member 2640E engages one entrance of member 2640A and member 2650A engages one exit of member 2640A.

Seen from interior perspective view 3300 of FIG. 33, engaged entrance 3411 of unfolded modular member 3420 maps to opening 3310A and engaged exit 3421 maps to opening 3311.

Now, referring to FIG. 34C, non-limiting exemplary unfolded modular member 3440 is provided. Unfolded modular member 3440 has two engaged entrances 3411 and two engaged exits 3421. The two engaged exits 3421 are on opposite walls so this member may be folded around a double-exit virtual pathway 1920 of FIG. 19B, or a tri-exit virtual pathway 1940 of FIG. 19D, or a quad-exit virtual pathway 1950 of FIG. 19E.

Seen from interior perspective view 3300 of FIG. 33, a first engaged entrance 3411 and first engaged exit 3421 of unfolded modular member 3440 map to opening 3311, as do the remaining second engaged entrance 3411 and second engaged exit 3421, such that, by rotating the refolded modular member 180 degrees, view 3300 of FIG. 33 is able to capture each of the four engaged openings.

Now, referring to FIG. 34D, non-limiting exemplary unfolded modular member 3460 is provided. Unfolded modular member 3460 has five engaged entrances 3411 and four engaged exits 3421. This unfolded member 3460 may be folded around a quad-exit virtual pathway 1950 of FIG. 19E, and it is engaged with at least nine other members: one member connecting to engaged entrance 3411 on the top, four members connecting to the engaged entrances 3411 on the four sides, and four members connecting to the engaged exits 3421 on the four sides.

Views of the unfolded modular members 3400, 3420, 3440 or 3460, with any number or combination of engaged entrances 3411, or engaged exits 3421, or disengaged entrances 3410 or disengaged exits 3420 may, in one embodiment, be viewed with a console 110 of FIG. 1 in conjunction with digital tools or apps.

Now, referring to FIG. 35A-35C, each figure provides possible openings of a modular member in triangular arrangements 3500, 3520, and 3540 in one embodiment. The circles in these arrangements represent possible openings which may be either engaged or disengaged openings. These are called possible openings because, for example, in some embodiments, only the bottom-exit module includes a bottom exit, while it also has no side exits. As another example, the double-exit module, in some embodiments, has no bottom exit and only has two side exits. The openings may be either entrances or exits into or out of a modular member. Like the unfolded modular members 3400, 3420, 3440 or 3460 of FIG. 34, the ten openings in each of FIG. 35A-35C may be mapped to the ten entrance and exit positions of the physical modular members or their associated virtual pathway modules 1910, 1920, 1930, 1940, 1950 or 1960 of FIG. 19A-19F. The mapping of the circular openings in the triangular arrangements 3500, 3520 or 3540 may be consistent (with each circle position maintaining the same mapping to the associated pathway module links and nodes) or the mapping of the triangular arrangements of circles to the links and nodes of the pathway modules may be scrambled or unpredictable. Other arrangements of the circles are also contemplated in the present invention. Views of the triangular (or other) arrangements may be viewed with a console of FIG. 1 in conjunction with digital tools or apps.

Now, referring to FIG. 36A, FIG. 36B, FIG. 36C, and FIG. 36D, a non-limiting exemplary embodiment of a mobile app is provided. This embodiment shares various features with the embodiment provided in FIG. 14A-14D. FIGS. 36A-36C show three views of the same 12-member configuration: a plan view 3610; an elevation view 3620; and a perspective view 3630. Each of these views depicts the placement of the 12th member 3617 of the configuration and this 12th member 3617 is highlighted as being in the “active” layer by use of a darker tone for the fill between the lines bounding the edges of the member. FIG. 36D provides an embodiment of a mobile app 3600 in which: plan view 3610 and active layer member 3617 can be seen in a lower portion of the screen; and perspective view 3630 and active layer member 3617 can be seen in an upper portion of the screen. A user may scroll from layer to layer, and with this configuration as an example, scrolling down to layer one would result in the removal of ten of the members from the screen leaving just the two bottom members 3618A, 3618B.

Now, referring to FIG. 37A, FIG. 37B and FIG. 37C, an embodiment of three plan views by layer 3700 and three perspective views by layer 3701 is provided. A non-limiting exemplary multi-layer configuration 3741 is provided in FIG. 37C. The layer-by-layer plans and perspectives of FIG. 37A and FIG. 37B demonstrate one way to depict the construction of the bottom three layers of the multi-layer configuration 3741. Many other configurations of the members are possible, as discussed above and provided in at least FIG. 26A, FIG. 30, FIG. 31 and FIG. 36C. Layer one plan view 3710 comprises four bottom-exit members, each of these being on the “active” layer one, with one bottom-exit member 3715A of the four labeled here. Layer one perspective view 3711 is one means of rendering this four-member layer in perspective. Bottom-exit member 3715C in perspective view 3711 is the perspectival rendition of the plan view of bottom-exit member 3715A of layer one plan view 3710.

A user may construct the first three layers of multi-layer configuration 3741 by: following layer one plan view 3710 and laying out the four “active” members as shown in layer one perspective view 3711; then following layer two plan view 3720 and laying out the two “active” members as shown in layer two perspective view 3721; and then following layer three plan view 3730, and laying out the three “active” members as shown in layer three perspective view 3731. Accordingly, four bottom-exit members are added for layer one 3710, 3711, two double-exit members are added to these first four for layer two 3720, 3721, and one double-exit member is added to the previous six members for layer three 3730, 3731. These members of each layer that are sequentially added to build the configuration taller and taller layer by layer are the “active” members of the layer.

Layer two plan view 3720 comprises the four bottom-exit members of layer one plan view 3710 with the addition of two “active” double-exit members. The four bottom-exit members are “non-active” and are just shown below to provide context and orientation for the user. One double-exit member 3722A is shown connecting to bottom-exit member 3715B and a second bottom-exit member that is unlabeled. Bottom-exit member 3715A and bottom-exit member 3715B refer to the same member in the configuration, the difference is just that the former is drawn with a bold outline to signify it is in the “active layer,” while the latter is drawn with a thin outline to signify it is in a lower “non-active” layer. Such a lower “non-active” member is already part of a built configuration, below the “active” layer. In plan view 3710, the four bottom-exit members shown are part of the “active” layer and thus are drawn with a bold border to call out to a user looking at this layer one plan view 3710 that these are members to be added to a physical construction the user may choose to build.

Layer three plan view 3730 comprises one double-exit member 3732A in the “active” layer, while the other six members shown in layer three plan view 3730 are “non-active” members below layer three that were added to the configuration earlier in layer one 3710 and layer two 3720. Layer three perspective view 3731 shows the addition of double-exit member 3732C (which corresponds to layer three plan view 3730 double-exit member 3732A). The varying darkness of the members in this embodiment of the perspective views of FIG. 37B and FIG. 37C relates to different colors of the various members. It will be appreciated that other rendering techniques or drawing conventions may be used and that the members of each “active” layer could be called out and highlighted in the perspective views to distinguish these from the members added in previous layers (or steps) in the assembly or construction process. The seven members which comprise layer three perspective view 3731 may also be called “the simple seven base.” This is a sturdy base configuration upon which may serve as the foundation upon which more members may be added in a plurality of combinations. Multi-layer configuration 3741 is just one of many possible configurations which may include the simple seven base 3731.

In some embodiments, design challenges may be presented for a user to attempt. For example, a user may be asked to attempt to make a design (a configuration) that remains within a 3×3 grid in plan view, or 5×5 grid in plan view, or any other ratio of grid in plan view. Such a challenge could be made not only to a single user, but for all users working on a shared design, such that all iterations would conform to this constraint.

As another example, a design challenge could be to make a design (or configuration) using certain module member patterns, such as zigzag or cascade patterns. A user, for example, could be challenged to design an iteration including three four-member zigzags and one five-member cascade. Or the challenge could be to include one red three-member cascade and one green three-member cascade.

In some embodiments, guided learning tools may have a teacher page in which teachers may design and develop such challenges and have settings for adjusting these challenges. These challenges themselves may be saved for later use by the teacher. The challenges may be given to students of the teacher, for example. An artificial intelligence engine may assist in providing these challenges to students at appropriate moments in their progress using the tools, or app or apps. These challenges may be shared by the teacher to another friend who may also be a teacher. In this way teachers may collaborate on developing best challenges for students. These users, designated as teachers, may also choose to submit their challenges for possible inclusion in teacher tools that could be accessed by some or all teacher users of the app or apps or other digital tools of the present invention. It will be appreciated that teacher/student could equally apply to counselor/client or patient, therapist or medical professional/patient, etc.

In some embodiments, educational or brain challenges may feel like games. For example, a rendered perspective view of a configuration could be presented to a user and the challenge is to draw the two-dimensional plan layer by layer that corresponds to that rendered perspective view. Alternatively, more and more members could be added to this configuration as an ongoing challenge for the user to keep drawing more and more layers.

In one embodiment, a user may decide to play a game using a configuration. Buttons or tools for choosing to play a game with a configuration may be available from the screens of the user interface.

The result of playing a game could be the creation of a new pathway or configuration which could be saved. This can be seen in FIG. 3 with playing a game, at 312, and saving, at 320. This new pathway or configuration could then be opened at 301, 401, or 520.

In one embodiment, a user may choose to be, or may be designated as, a game master. This user could design a configuration which could then be used by the game master alone for playing games or could be used by a group of users. The group of users may be friends of the game master within the app. In some embodiments the game to be played could include the ability of various users to control player characters who may explore the pathways of a configuration. NPCs as marbles (or as orcs or trolls) could descend down a pathway guided by a physics engine or the virtual world engine 211 or by calculations of the pathway engine 231.

In one embodiment, users who play a digital game using a saved configuration or pathway graph may choose to build a real-world model of this configuration using modular members. Rolling marbles through such a real-world model could assist in anticipating how play may transpire in the digital version, especially with respect to movement of NPCs descending the pathway graph.

In another embodiment, players do not know the configuration in advance of playing the game and part of the game play is coming to understand the nature of the configuration one is inhabiting during the game. For example, one could play a game and eventually determine that it is being played in a model of a fish (such as 3100 of FIG. 31), and that there is something special, for example, about the eye vs. the mouth vs. the tail.

In another embodiment, not just the pathway and the entries and exits in and out of pathway modules, or modular members, or chambers has meaning in the game, also the color of a member or the colors of a sequence of members may have meaning in the game as well to drive the nature of what occurs in the game, in the spaces, with the NPCs and player characters. For example, if a blue single-exit member is followed by a red single-exit member leading into a blue double-exit member, then some designated event or characteristic may occur in any of these or surrounding members.

In one embodiment, a game could be a casual game, meaning a game that may be played on a mobile app and be completed in just a few minutes or even in just a minute or less, or may be played in small chunks of a minute or so at a time. A non-limiting example of such a game could be a game in which the configuration explodes when all of the marbles get to the bottom of the configuration. For such a game, a player may choose a configuration to load or open, with it optionally coming from one of the databases associated with the configuration engine 201. Then the player may choose to send marbles through the configuration and watch them flow and cascade through the configuration. Then when the marbles have all reached the bottom, or alternatively, while the marbles are still flowing down the configuration, the configuration explodes. A physics engine or the virtual world engine 211 could provide the video renderings that depict this explosion. A user designing configurations using tools such as the design screen 680, may choose to design the configuration in ways that optimize the characteristics of the explosion.

In some embodiments, a game may be played by one of more users using one or more configurations.

In some embodiments, while a game is being played by one or more users, other users may view the game during play and may see the progress of the player characters and non-player characters as they move along the pathway graph or graphs of the game. These viewing users may be able to view the game from any view, such as perspective, plan, section, elevation, unfolded or combination of views. Users may also view the game from a first-person perspective or a third-person perspective. A player of a game may also be able to view the progress made in this way and thus have an omniscient view (or third person view) of the game while also being immersed in the spaces of the game itself (such as with a first-person view) which may include photo realistic rendered animation.

In some embodiments, a player may be able to use physical modular members at the same time they are playing the game or watching other users play the game. This form of play may be especially conducive to use of augmented reality goggles or glasses. In such a case the user, building with physical members, could see video game player characters and NPCs superimposed upon reality and roaming through the real-world members they are assembling. Conversely, the users playing the game and controlling the player characters could have the configuration in which they are playing transforming in real time as the player who is adding and subtracting members from the real-world configuration is causing the digital configuration in which the game is being played to transform accordingly.

In some embodiments, a user may be able to rate a configuration, or a draft configuration, or a design, or a challenge or a game.

In some embodiments, how often a design is opened, or played as a game, or iterated, or viewed may contribute to its evaluation by the curation engine 261 or the configuration test engine 271.

In some embodiments, users may be able to highlight sections or particular members of a configuration. These highlighted sections or members may then be tagged by the user. The data associated with this may be collated by the curation engine 261 and could provide data for ranking a configuration or providing information a user could review for making adjustments to a design.

In some embodiments, a game could be a wagering game related to the end result of where one or a plurality of marbles or one or a plurality of colors ends up at the bottom of a pathway.

In another embodiment, a challenge or a game could be to connect one or more lower members to a higher member that is floating in space. Or alternatively the only constraint may be that there are one or more members already located on layers above the bottom layer and the challenge may be to make a configuration that incorporates these members.

In another embodiment, a game could be to view a configuration and then to send members flying off of the configuration with a finger gesture or swipe on the screen, thus removing chosen members from the configuration. A physics engine or the virtual world engine 211 could render animations of such members flying away from the configuration. Alternatively, the members could be programmed to circle back, to kind of boom-a-rang back and reattach somewhere on the configuration. A user would flick members away, only to have them reattach. Such reattachment could be random or could be driven by some design. In one embodiment, two or more designs could be chosen and the flicking process and the flying back and reattaching is toward the configuration morphing from the first configuration into the second configuration.

One embodiment includes a game during which a configuration may be created as a result of the game play. This configuration may be saved during or at the conclusion of the game. A user may later open this configuration at 301 and use it in the various ways afforded by the system 200 and the method 300.

One embodiment of the invention allows one or more users to navigate player characters along a pathway or pathway network or pathway graph, which may be composed of multiple virtual pathway modules. The player characters may travel upward or downward along this pathway, regardless of whether they pass through entrances or exits, there thus being no necessary wrong way of travel NPCs may descend the pathway as they play. Alternatively, NPCs may travel both up and down pathways.

In one embodiment a player may be navigating a pathway of a configuration. Another player or an AI may be actively editing this configuration and pathway during play by the first user/player.

In one embodiment the randomization engine or the pathway engine 231 provides data that signals the appearance of physics-obeying NPCs that may be engaged by the player character within a chamber or in reference to a core node 845. In some embodiments, there may not be separate rooms or spaces around each core node, one or more core nodes of a pathway may all reside in one space or be divided among one or more spaces. A racing game, for example, may be rendered as a road network in one outdoor space.

In one embodiment each core node 845 is associated with five potential entrances and five potential exits which correspond to potential entrances and exits of modular members. Any number of these potential exits or entrances may be activated or not, may be closed or open, may be passable or impassable.

In another embodiment there may be a one or a plurality of entrances associated with a core node 845 and one or a plurality of exits associated with a core node 845.

In one embodiments renderings of a space associated with a core node may be photorealistic renderings closely approximating the modular members.

In one embodiment, the computer-rendered space associated with a core node 845 may be rendered as spaces within a building, a dungeon, a network of caves, a series of clouds, or an underwater environment.

In one embodiment, the vertical Z-dimension may be completely flattened so that all pathways and entrances and exits may overlap on a two-dimensional playing surface that is horizontal. Entrances and exits of one or two or more virtual pathway modules, that would otherwise be vertically separated, may then be in close proximity to one another. This may allow a player character to “teleport” from one module to another skipping over sections of a virtual pathway in the process.

In another embodiment, the vertical Z-dimension may be partially flattened thus created more of an undulating terrain, a terrain that is not as steep as the as when the modules are cubic.

In one embodiment entrances and exits, single or a plurality, may be linked to a core node 845 of a different member allowing an NPC or a player character to teleport from one location to another, thus bypassing any number of modules of the pathway.

In one embodiment the randomizer engine or pathway engine 231 may be used in a wagering or gambling device.

In one embodiment NPCs may be assigned different colors. For example, one NPC could be rendered as a red marble and another rendered as a blue marble.

In one embodiment the color of a modular member may afford certain characteristics impacting the game experience of a player character or a non-player character. For example, a red single-exit member could increase the dwell time of an NPC, or a blue double-exit member could decrease the dwell time of an NPC.

In one embodiment, a configuration may be viewed via a console alternatively as though it is composed of modular members which may be of particular chosen colors, or the configuration or associated pathways may be viewed as rendered to mimic some other structure or environment such as a castle, or forest, or roadway, or cave network. These views with different characteristics may be called rendering modes. The different rendering modes may also coincide with different degrees of magnification or collapsing or distortion of any of the X, Y or Z coordinates.

In one embodiment a user may take a photo of a real-world construction and an artificial intelligence engine 291 may build a virtual version of this. The virtual version may have X, Y, Z coordinate and other data that may be saved to the configuration engine 211.

In one embodiment, a game may be a casual game—a game that only takes a short time to complete, typically less than 1 or 3 minutes.

In one embodiment a game may allow a user to open a configuration and watch that configuration assemble member by member.

In one embodiment a player may be able to open a configuration and watch NPC characters descend the configuration. These characters NPCs may descend according to a physics engine. These NPCs may descend in a method assigned by the randomization engine or pathway engine 231.

In one embodiment two or more players may navigate the pathways of a configuration. A first player may follow one route along the pathways and a second player may follow another route. The different routes may be a result of diverging and converging nature of the pathways in accordance with the different member or virtual pathway module types.

In one embodiment NPCs may be loaded into the top of, or another area of, a configuration. These may descend according to the pathway engine 231. A first player in one location of a configuration and a second player in another location of a configuration both have a probability of encountering an NPC of the same flow that was initiated higher up the configuration.

Any player may engage with an NPC and direct it toward one or another of the exits. A player may destroy an NPC, so it is no longer descending the pathway network graph.

In one embodiment the nodes connected by links form a graph that may be used to organize the movement of players and NPCs through a configuration.

In one embodiment a configuration test engine 271 keeps track of user data regarding their completion of guided learning exercises, games played, and configurations created or collaborated on.

In one embodiment, user data may be used to supply a player or user with challenges that are tuned to the user at a challenge level from easy to medium to hard.

In one embodiment users may rank games and exercises and guided learning lessons and configurations as easy, medium or hard or some other set of metrics for assessing and recording perceived challenge level or difficulty.

In one embodiment the challenge or difficulty scores assessed by a first player may be compared to the challenge or difficulty rankings of another player or a composite difficulty over a plurality of players.

Embodiments of the present disclosure may be practiced with various computer system configurations including microprocessor systems, handheld devices, programmable consumer electronics, minicomputers, large computer and any other known or after-arising computing system. Embodiments of the present disclosure may also be accessed in distributed computing environments where tasks may be performed by remote processing devices that may be linked through a wireless or wired network, for example. It will be understood that embodiments of the present disclosure may employ various computer-implemented operations involving data stored in computer systems. Such operations may use physical manipulation of physical quantities. Any of the operations are useful machine operations and relate to devices or an apparatus for performing these operations. The apparatus can be a general-purpose computer selectively activated or configured by a computer program stored in the computer, or it may be specially constructed for the required purpose. Various general-purpose machines may be used with computer programs written in accordance with the disclosure provided herein, or constructed to a more specialized apparatus to perform the operations.

Some embodiments of the present disclosure may include computer readable code on a computer readable medium. The computer-readable medium may be any data storage device that can store data that can be read by a computer system. For example, the computer readable medium includes, but is not limited to hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

Although various representative embodiments of this disclosure have been described above with a certain degree of particularity, those skilled in the art could make numerous alterations to the disclosed embodiments without departing from the spirit or scope of the inventive subject matter. Accordingly, the present embodiments are to be considered as illustrative and not restrictive, and the embodiments are not to be limited to the details given herein, but may be modified within the scope and equivalents set forth in the specification and claims.

What is claimed is:

1. A computer-based system for virtual navigation, the system comprising:
a server for managing the virtual navigation of one or more non-player characters; and
at least one player console in operable communication with the server over a network, each of at least one player console comprising a gaming platform for executing a gaming environment, wherein the server generates a virtualized flow of randomly colliding non-player characters, each of which descend through a structure with varying dwell times at one or more chamber nodes and then exit at an end of the dwell time for a given non-player character.

2. The system of claim 1, wherein the one or more chamber nodes includes up to five entrances and up to five exits that correspond to up to five entrances and up to five exits on a corresponding number of modular members.

3. The system of claim 2, wherein a plurality of the one or more chamber nodes form a branching pathway for a player and non-player character to move through.

4. The system of claim 1, further comprising a pathway engine that computes the dwell time for one or more of the non-player characters.

5. The system of claim 4, wherein the non-player characters are marbles that travel downward along a pathway created by a series of linked pathway modules.

6. The system of claim 5, wherein the non-player characters travel upward and downward along the pathway.

7. A computer-based system for connected play, the system comprising:
a server for managing a virtual navigation of one or more non-player characters; and
a configuration engine in operable communication with the server over a network, wherein the configuration engine creates a user defined pathway or plurality of pathways for one or more non-player characters to travel through in the virtual navigation.

8. The system of claim 7, the configuration engine further comprising being in operable communication with a virtual world engine.

9. The system of claim 7, the configuration engine further comprising being in operable communication with a rendering engine.

10. The system of claim 7, the configuration engine further comprising being in operable communication with a pathway engine.

11. The system of claim 7, the configuration engine further comprising being in operable communication with a search engine.

12. The system of claim 7, the configuration engine further comprising being in operable communication with a layout engine.

13. The system of claim 7, the configuration engine further comprising being in operable communication with a curation engine.

14. The system of claim 7, the configuration engine further comprising being in operable communication with a configuration test engine.

15. The system of claim 7, the configuration engine further comprising being in operable communication with a spatial reasoning engine.

16. The system of claim 7, the configuration engine further comprising being in operable communication with an artificial intelligence engine.

17. The system of claim 7, the configuration engine further comprising being in operable communication with a virtual world engine, a rendering engine, a pathway engine, a search engine, a layout engine, a curation engine, a configuration test engine, a spatial reasoning engine, and an artificial intelligence engine.

18. A method of connected play for at least one user of a computer-based virtual navigation game, the method comprising:
opening a digital configuration within an application running the computer-based virtual navigation game;
digitally drawing in the application a new configuration of the digital configuration that was opened;
saving the new digital configuration in the application; and
sharing the new digital configuration in the application.

19. The method of claim 18, wherein the new configuration is an iteration of the digital configuration that was opened.

20. The method of claim 18, further comprising playing the game using the new configuration.
